(19) United States
(12) Patent Application Publication
(10) Pub. No.: US 2016/0342241 A1
(43) Pub. Date: Nov. 24, 2016

(54) ELECTRONIC DEVICE INCLUDING TOUCH PANEL AND METHOD OF CONTROLLING SAME

(71) Applicant: Samsung Electronics Co., Ltd., Gyeonggi-do (KR)

(72) Inventors: Gih-Sung CHUNG, Gyeonggi-do (KR); Sung-Chul PARK, Seoul (KR); Cheol-Ho CHEONG, Seoul (KR); So-Young KIM, Gyeonggi-do (KR); Sook-Jin KIM, Gyeonggi-do (KR); Moon-Bae SONG, Seoul (KR); Seung-Eun LEE, Seoul (KR); Sun-Ok JUNG, Gyeonggi-do (KR); Ik-Hwan CHO, Gyeonggi-do (KR); Joon-Ho CHO, Gyeonggi-do (KR); Jae-Woong CHUN, Gyeonngi-do (KR)

(21) Appl. No.: 15/079,694

(22) Filed: Mar. 24, 2016

(30) Foreign Application Priority Data
May 22, 2015 (KR) 10-2015-0072148

(51) Int. Cl. G06F 3/044; G06F 3/01

(52) U.S. Cl. CPC G06F 3/044; G06F 3/015; G06F 2203/04104

(57) ABSTRACT

A method for controlling an electronic device including a touch panel, the method comprising: acquiring a first signal from a first area of the touch panel and acquiring a second signal from a second area of the touch panel; detecting whether a potential difference of the first signal and the second signal is larger than a preset threshold; and detecting whether a first touch corresponding to the first area and a second touch corresponding to the second area are performed by using one hand based on whether the potential difference of the first signal and the second signal is larger than the preset threshold.

### CLAIM OF PRIORITY

This application claims priority under 35 U.S.C. §119(a) to Korean Application Serial No. 10-2015-0072148, which was filed in the Korean Intellectual Property Office on May 22, 2015, the entire content of which is hereby incorporated by reference.

### TECHNICAL FIELD

The present disclosure relates to electronic devices in general, and more particularly, to an electronic device including a touch panel and method for controlling the same.

### BACKGROUND

Recently, the development of electronic devices including a touch panel has been rapidly progressed. The electronic device including the touch panel may grasp proximity information on a user or an object. For example, the electronic device including the touch panel may detect a location of a user or an object in proximity to the electronic device and conduct an action corresponding to the location. Accordingly, in a mobile environment in which an input means is limited, the electronic device including the touch panel is spotlighted in a mobile environment since various functions through the touch panel can be guaranteed.

### SUMMARY

According to aspects of the disclosure, a method is provided for controlling an electronic device including a touch panel, the method comprising: acquiring a first signal from a first area of the touch panel and acquiring a second signal from a second area of the touch panel; detecting whether a potential difference of the first signal and the second signal is larger than a preset threshold; and detecting whether a first touch corresponding to the first area and a second touch corresponding to the second area are performed by using one hand based on whether the potential difference of the first signal and the second signal is larger than the preset threshold.

According to aspects of the disclosure, an electronic device is provided comprising: a touch panel; a memory; and at least one processor operatively coupled to the memory, configured to: acquire a first signal from a first area of the touch panel and acquiring a second signal from a second area of the touch panel; detect whether a potential difference of the first signal and the second signal is larger than a preset threshold; and detect whether a first touch corresponding to the first area and a second touch corresponding to the second area are performed by using one hand based on whether the potential difference of the first signal and the second signal is larger than the preset threshold.

According to aspects of the disclosure, an electronic device is provided comprising: a touch panel arranged to acquire a plurality of electric signals; a filter arranged to pass a first frequency band, the filter being operatively coupled to the touch panel; a memory, and at least one processor operatively coupled to the memory, configured to: sense an electrocardiogram (ECG) by using a first signal from the plurality of electric signals being in the first frequency band; identify a touch position on the touch panel by using a second signal from the plurality of electric signals being in a second frequency band.

According to aspects of the disclosure, an electronic device is provided comprising: a touch panel in which electrode cells are connected or separated through Thin Film Transistors (TFTs); a memory; at least one processor operatively coupled to the memory, configured to: select whether to identify a touch position on the touch panel or sense an ECG of a user, and cause the electrode cells to be connected or separated from each other through the TFTs according to an outcome of the selection.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram of an example of an electronic device and a network, according to various embodiments;

FIG. 2 is a block diagram of an example of an electronic device, according to various embodiments;

FIG. 3 is a block diagram of an example of a program module, according to various embodiments;

FIG. 4A is a flowchart of an example of a process, according to various embodiments;

FIG. 4B is a flowchart of an example of a process, according to various embodiments;

FIG. 5A is a diagram of an example of an electronic device, according to various embodiments;

FIG. 5B is a diagram of an example of an electronic device, according to various embodiments;

FIG. 5C is a diagram of an example of an electronic device, according to various embodiments;

FIG. 5D is a diagram of an example of an electronic device, according to various embodiments;

FIG. 5E is a signal graph associated with the electronic device of FIGS. 5A-D, according to various embodiments;

FIG. 6A is a diagram of an example of an electronic device, according to various embodiments;

FIG. 6B is a diagram of an example of an electronic device, according to various embodiments;

FIG. 6C is a diagram of an example of an electronic device, according to various embodiments;

FIG. 6D is a diagram of an example of an electronic device, according to various embodiments;

FIG. 7 is a diagram of an example of electronic device, according to various embodiments;

FIG. 8A is a flowchart of an example of a process, according to various embodiments;

FIG. 8B is a flowchart of an example of a process, according to various embodiments;

FIG. 9A is a diagram of an example of a Thin Film Transistor (TFT), according to various embodiments;

FIG. 9B is a diagram of an example of a Thin Film Transistor (TFT), according to various embodiments;

FIG. 9C is a diagram of an example of a Thin Film Transistor (TFT), according to various embodiments;

FIG. 10 is a flowchart of an example of a process, according to various embodiments;

FIG. 11 is a flowchart of an example of a process, according to various embodiments;

FIG. 12A is a diagram of an example of an electronic device, according to various embodiments;

FIG. 12B is a diagram of an example of an electronic device, according to various embodiments;

FIG. 13 is a flowchart of an example of a process, according to various embodiments;

FIG. 14A is a diagram of an example of an electronic device, according to various embodiments;

FIG. 14B is a diagram of an example of an electronic device, according to various embodiments;

FIG. 15 is a diagram of an example of an electronic device, according to various embodiments;

FIG. 16 is a flowchart of an example of an electronic device, according to various embodiments;

FIG. 17A is a flowchart of an example of a process, according to various embodiments;

FIG. 17B is a flowchart of an example of a process, according to various embodiments;

FIG. 18A is a diagram of an example of an electronic device, according to various embodiments;

FIG. 18B is a diagram of an example of an electronic device, according to various embodiments;

FIG. 18C is a diagram of an example of an electronic device, according to various embodiments;

FIG. 18D is a diagram of an example of an electronic device, according to various embodiments;

FIG. 19 is a flowchart of an example of a process, according to various embodiments;

FIG. 20 is a diagram of an example of an electronic device, according to various embodiments;

FIG. 21 is a flowchart of an example of a process, according to various embodiments;

FIG. 22A is a diagram of an example of an electronic device, according to various embodiments;

FIG. 22B is a diagram of an example of an electronic device, according to various embodiments;

FIG. 23A is a flowchart of an example of a process, according to various embodiments;

FIG. 23B is diagram illustrating the operation of the process of FIG. 23A according to various embodiments;

FIG. 24 is a diagram of an example of a system, according to various embodiments;

FIG. 25 is a diagram of an example of an electronic device, according to various embodiments;

FIG. 26 is a diagram of an example of an electronic device, according to various embodiments;

FIG. 27 is a diagram of an example of an electronic device, according to various embodiments;

FIG. 28 is a diagram of an example of an electronic device, according to various embodiments;

FIG. 29 is a flowchart of an example of a process, according to various embodiments;

FIG. 30 is a flowchart of an example of a process, according to various embodiments;

FIG. 31 is a flowchart of an example of a process, according to various embodiments; and

FIG. 32A illustrates an example of payment security information, according to various embodiments; and

FIG. 32B illustrates an example of payment security information, according to various embodiments.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

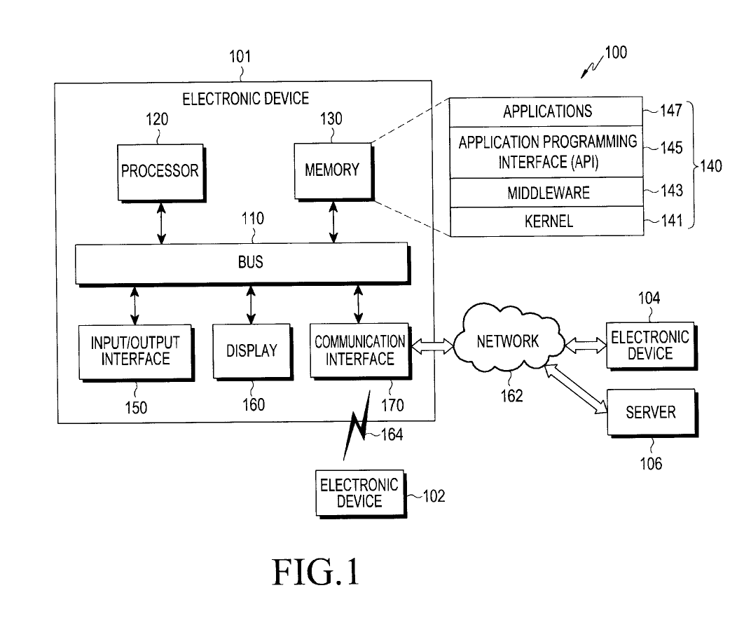

FIG. 1 is a block diagram of an example of an electronic device 101 and a network system, according to various embodiments. The electronic device 101 may include a bus 110, a processor 120, a memory 130, an input/output interface 150, a display 160, and a communication interface 170. According to some embodiments, the electronic device 101 may omit at least one of the above component elements or may further include other component elements.

The bus 110 may include, for example, a circuit which interconnects the elements 110 to 170 and delivers communication (for example, a control message and/or data) between the elements 110 to 170.

The processor 120 may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. For example, the processor 120 may include one or more of a Central Processing Unit (CPU), an Application Processor (AP), and a Communication Processor (CP). The processor 120 may carry out, for example, operations or data processing related to the control and/or communication of at least one other element of the electronic device 101.

The memory 130 may include any suitable type of volatile or non-volatile memory, such as Random-access Memory (RAM), Read-Only Memory (ROM), Network Accessible Storage (NAS), cloud storage, a Solid State Drive (SSD), etc. The memory 130 may store, The memory 130 may store, for example, instructions or data relevant to at least one other element of the electronic device 101. According to an embodiment, the memory 130 may store software and/or a program 140. The program 140 may include a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (for example, the bus 110, the processor 120, or the memory 130) used for executing an operation or function implemented by other programs (for example, the middleware 143, the API 145, or the application program 147). Furthermore, the kernel 141 may provide an interface through which the middleware 143, the API 145, or the application programs 147 may access the individual component elements of the electronic device 101 to control or manage the system resources.

The middleware 143 may serve, for example, as an intermediary for allowing the API 145 or the application programs 147 to communicate with the kernel 141 to exchange data.

In addition, the middleware 143 may process one or more task requests received from the application programs 147 according to priorities thereof. For example, the middleware 143 may assign priorities for using the system resources (for example, the bus 110, the processor 120, the memory 130, or like) of the electronic device 101 to at least one of the application programs 147. For example, the middleware 143 may perform scheduling or load balancing on the one or more task requests by processing the one or more task requests according to the priorities assigned thereto.

The API 145 is an interface through which the applications 147 control functions provided from the kernel 141 or the middleware 143, and may include, for example, at least one interface or function (for example, instruction) for file control, window control, image processing, or text control.

The input/output interface 150 may serve as, for example, an interface that may transfer instructions or data input from a user or another external device to the other element(s) of the electronic device 101. Also, the input/output interface 150 may output instructions or data received from other element(s) of the electronic device 101 to the user or another external device.

The display 160 may include, for example, a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (for example, text, images, videos, icons, or symbols) to the user. The display 160 may include a touch screen and receive, for example, a touch, gesture, proximity, or hovering input using an electronic pen or a user's body part.

The communication interface 170 may establish communication between, for example, the electronic device 101 and an external device (for example, a first electronic device 102, a second electronic device 104, or a server 106). For example, the communication interface 170 may be connected to a network 162 through wireless or wired communication to communicate with an external device (for example, the second external electronic device 104 or the server 106).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may include, for example, a short range communication 164. The short-range communication 164 may include at least one of, for example, Wi-Fi, Bluetooth, Near Field Communication (NFC), and a Global Navigation Satellite System (GNSS), and the like. The GNSS may include at least one of, for example, a Global Positioning System (GPS), a Global navigation satellite system (Glonass), a Beidou navigation satellite system (hereinafter, referred to as “Beidou”), and Galileo (European global satellite-based navigation system). Hereinafter, in the present disclosure, the “GPS” may be interchangeably used with the “GNSS”. The wired communication may include at least one of, for example, a Universal Serial Bus (USB), a High Definition Multimedia Interface (HDMI), Recommended Standard 232 (RS-232), and a Plain Old Telephone Service (POTS). The network 162 may include at least one of telecommunication networks such as a computer network (for example, a LAN or a WAN), the Internet, and a telephone network.

Each of the first and second external electronic devices 102 and 104 may be of a type that is identical to or different from that of the electronic device 101. According to an embodiment, the server 106 may include a group of one or more servers. According to various embodiments of the present disclosure, all or some of the operations performed in the electronic device 101 may be performed in another electronic device or a plurality of electronic devices (for example, the electronic devices 102 and 104, or the server 106). According to an embodiment, when the electronic device 101 should perform some functions or services automatically or by request, the electronic device 101 may make a request for performing at least some functions related to the functions or services to another device (for example, the electronic device 102 or 104 or the server 106) instead of performing the functions or services by itself. Another electronic device (for example, the electronic device 102 or 104, or the server 106) may execute the requested functions or the additional functions, and may deliver a result of the execution to the electronic device 101. The electronic device 101 may provide the received result as it is or additionally process the result and provide the requested functions or services. To achieve this, for example, cloud computing, distributed computing, or client-server computing technology may be used.

According to various embodiments, the electronic device 101 may further include a touch panel (not shown). The touch panel (not shown) may be included in the electronic device 101 as a part of or independently from the display 160. The memory 130 may store instructions to instruct the processor 120 to acquire a first electric signal from a first area of the touch panel, to acquire a second electric signal from a second area of the touch panel, to determine whether at least one of the indicators of a potential difference of the first electric signal and the second electric signal is larger than a preset threshold, and to determine whether a first touch corresponding to the first area and a second touch corresponding to the second area is made by one hand or both hands according to whether at least one of the indicators of the potential difference of the first electric signal and the second electric signal is larger than the preset threshold when the instructions are executed.

According to various embodiments, the memory 130 may store instructions to instruct the processor 120 to determine that the first touch and the second touch are made by both hands when the one or more of the indicators of the potential difference of the first electric signal and the second electric signal is larger than the preset threshold, and to determine that the first touch and the second touch are made by one hand when the one or more of the indicators of the potential difference of the first electric signal and the second electric signal is equal to or smaller than the preset threshold when the instructions are executed.

According to various embodiments, the memory 130 may further store instructions to instruct the processor 120 to control the electronic device to perform a preset event corresponding to the first touch and the second touch by both hands when it is determined that the first touch and the second touch are made by both hands, and to control the electronic device to perform a preset event corresponding to the first touch and the second touch by one hand when it is determined that the first touch and the second touch are made by one hand when the instructions are executed.

According to various embodiments, the memory 130 may further store instructions to instruct the processor 120, when the indicator of the potential difference is the potential difference of the first electric signal and the second electric signal, to determine that the first touch and the second touch are made by both hands if it is determined that the potential difference is larger than a first threshold and to determine that the first touch and the second touch are made by one hand if it is determined that the potential difference is equal to or smaller than the first threshold, when the indicator of the potential difference is a strength of the potential difference of the first electric signal and the second electric signal in a first frequency band, to determine that the first touch and the second touch are made by both hands if it is determined that the strength in the first frequency band is larger than a second threshold and to determine that the first touch and the second touch are made by one hand if it is determined that the strength in the first frequency band is equal to or smaller than the second threshold, or, when the indicator of the potential difference is a similarity between the potential difference of the first electric signal and the second electric signal and a pre-stored ECG template, to determine that the first touch and the second touch are made by both hands if it is determined that the similarity is larger than a third threshold and to determine that the first touch and the second touch are made by one hand if it is determined that the similarity is equal to or smaller than the third threshold.

According to various embodiments, the electronic device 101 may further include a processing module that measures the indicators of the potential difference of the first electric signal and the second electric signal, acquired through the touch panel.

According to various embodiments, the electronic device 101 may further include a filter configured to be connected to the touch panel and allow a first frequency band signal of the one or more electric signals to pass therethrough.

According to various embodiments, the memory 130 may store instructions to instruct the processor 120 to sense an ECG by using the first frequency band signal and to determine a touch position on the touch panel by using a second frequency band signal of the one or more electric signals when the instructions are executed.

According to various embodiments, the memory 130 may further store instructions to instruct the processor 120 to control the electronic device by using at least one of the ECG and the touch position when the instructions are executed. The one or more electric signals may include a first electric signal output from a first area of the touch panel and a second electric signal from a second area.

According to various embodiments, the memory 130 may further store instructions to instruct the processor 120 to sense the ECG based on a potential difference of the first electric signal and the second electric signal when the instructions are executed.

According to various embodiments, the memory 130 may further store instructions to instruct the processor 120 to determine whether a first touch corresponding to the first area and a second touch corresponding to the second area are made by one hand or both hands according to whether one or more of indicators of a potential difference of the first electric signal and the second electric signal is larger than a preset threshold when the instructions are executed.

According to various embodiments, the memory 130 may further store instructions to instruct the processor 120 to control the electronic device to perform at least one of a first event corresponding to one hand and a second event corresponding to both hands according to whether the one or more of the indicators of the potential difference of the first electric signal and the second electric signal is larger than the preset threshold when the instructions are executed.

According to various embodiments, the electronic device 101 may further include a feedback circuit that extracts common mode noise of the first electric signal and the second electric signal and outputs an inverse phase signal of the extracted common mode noise to a third area of the touch panel. The first area and the second area may correspond to one or more channels of the touch panel.

According to various embodiments, the memory 130 may further store instructions to instruct the processor 120, when the indicator of the potential difference is the potential difference of the first electric signal and the second electric signal, to determine that the first touch and the second touch are made by both hands if it is determined that the potential difference is larger than a first threshold and to determine that the first touch and the second touch are made by one hand if it is determined that the potential difference is equal to or smaller than the first threshold, when the indicator of the potential difference is a strength of the potential difference of the first electric signal and the second electric signal in a first frequency band, to determine that the first touch and the second touch are made by both hands if it is determined that the strength in the first frequency band is larger than a second threshold and to determine that the first touch and the second touch are made by one hand if it is determined that strength in the first frequency band is equal to or smaller than the second threshold, or, when the indicator of the potential difference is a similarity between the potential difference of the first electric signal and the second electric signal and a pre-stored ECG template, to determine that the first touch and the second touch are made by both hands if it is determined that similarity is larger than a third threshold and to determine that the first touch and the second touch are made by one hand if it is determined that the similarity is equal to or smaller than the third threshold when the instructions are executed.

According to various embodiments, the electronic device 101 may include a touch panel in which electrode cells are connected or separated through Thin Film Transistors (TFTs). In this case, the memory 130 may store instructions to instruct the processor 120 to determine whether to perform a determination of a touch position on the touch panel or to sense an ECG of a user, and to make a control such that the electrode cells are connected to or separated from each other through the TFTs according to a result of the determination when the instructions are executed.

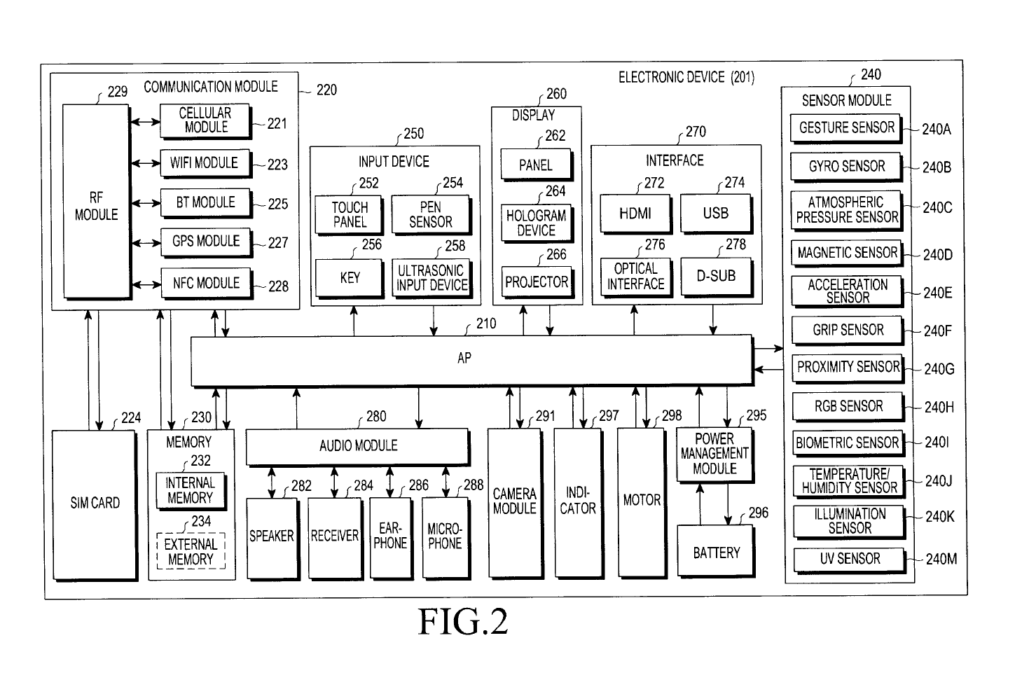

FIG. 2 is a block diagram of an example of an electronic device 201, according to various embodiments. The electronic device 201 may include, for example, the whole or part of the electronic device 101 illustrated in FIG. 1. The electronic device 201 may include one or more Application Processors (APs) 210, a communication module 220, a subscriber identification module 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software elements connected to the processor 210 by driving an operating system or an application program, and may process various pieces of data and calculations. The processor 210 may be implemented as, for example, a System on Chip (SoC). According to an embodiment, the processor 210 may further include a Graphic Processing Unit (GPU) and/or an image signal processor. The processor 210 may include at least some (for example, a cellular module 221) of the elements illustrated in FIG. 2. The processor 210 may load, into a volatile memory, instructions or data received from at least one (for example, a non-volatile memory) of the other component elements and may process the loaded instructions or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a Bluetooth module 225, a GNSS module 227 (for example, a GPS module, a Glonass module, a Beidou module, or a Galileo module), an NFC module 228, and a Radio Frequency (RF) module 229.

The cellular module 221 may provide, for example, a voice call, an image call, a text message service, or an Internet service through a communication network. According to an embodiment, the cellular module 221 may identify and authenticate the electronic device 201 within a communication network using the subscriber identification module (for example, an SIM card 224). According to an embodiment, the cellular module 221 may perform at least some of the functions that the processor 210 may provide. According to an embodiment, the cellular module 221 may include a Communication Processor (CP).

Each of the Wi-Fi module 223, the BT module 225, the GNSS module 227, and the NFC module 228 may include, for example, a processor for processing data that is transmitted and received through a corresponding module. According to some embodiments, at least some (two or more) of the cellular module 221, the Wi-Fi module 223, the BT module 225, the GNSS module 227, and the NFC module 228 may be included in one Integrated Chip (IC) or IC package.

The RF module 229 may transmit/receive, for example, a communication signal (for example, an RF signal). The RF module 229 may include, for example, a transceiver, a Power Amp Module (PAM), a frequency filter, a Low Noise Amplifier (LNA), an antenna, or the like. According to another embodiment, at least one of the cellular module 221, the Wi-Fi module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 230 (for example, the memory 130) may include, for example, an internal memory 232 or an external memory 234. The internal memory 232 may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory or a NOR flash memory), a hard driver, or a Solid State Drive (SSD).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a Multi-Media Card (MMC), a memory stick, or the like. The external memory 234 may be functionally and/or physically connected to the electronic device 201 through various interfaces.

The sensor module 240 may measure, for example, a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 240I, a temperature/humidity sensor 240J, a light sensor 240K, and an ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling at least one sensor included therein. According to an embodiment, the electronic device 201 may further include a processor configured to control the sensor module 240 as a part of the processor 210 or separately from the processor 210, and may control the sensor module 240 while the processor 210 is in a sleep state.

The input device 250 may include, for example, a touch panel 252, a (digital) pen sensor 254, a key 256, and an ultrasonic input unit 258. The touch panel 252 may use at least one of, for example, a capacitive type, a resistive type, an infrared type, and an ultrasonic type. Also, the touch panel 252 may further include a control circuit. The touch panel 252 may further include a tactile layer and may provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect ultrasonic waves generated by an input tool, through a microphone (for example, a microphone 288), and may identify data corresponding to the detected ultrasonic waves.

The display 260 (for example, the display 160) may include a panel 262, a hologram device 264 or a projector 266. The panel 262 may include a configuration identical or similar to that of the display 160 illustrated in FIG. 1. The panel 262 may be implemented to be, for example, flexible, transparent, or wearable. The panel 262 and the touch panel 252 may be configured as one module. The hologram device 264 may show a three dimensional image in the air by using an interference of light. The projector 266 may display an image by projecting light onto a screen. The screen may be located, for example, inside or outside the electronic device 201. According to an embodiment, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280 may bilaterally convert, for example, a sound and an electrical signal. At least some component elements of the audio module 280 may be included in, for example, the input/output interface 150 illustrated in FIG. 1. The audio module 280 may process sound information that is input or output through, for example, a speaker 282, a receiver 284, earphones 286, the microphone 288 or the like.

The camera module 291 is, for example, a device that may photograph a still image and a dynamic image. According to an embodiment, the camera module 291 may include one or more image sensors (for example, a front sensor or a back sensor), a lens, an Image Signal Processor (ISP) or a flash (for example, LED, xenon lamp, or the like).

The power management module 295 may manage, for example, power of the electronic device 201. According to an embodiment, the power management module 295 may include a Power Management Integrated Circuit (PMIC), a charger Integrated Circuit (IC), or a battery or fuel gauge. The PMIC may use a wired and/or wireless charging method. The wireless charging method may include, for example, a magnetic resonance method, a magnetic induction method, an electromagnetic wave method, and the like. Additional circuits (for example, a coil loop, a resonance circuit, a rectifier, etc.) for wireless charging may be further included. The battery gauge may measure, for example, a residual quantity of the battery 296, and a voltage, a current, or a temperature during the charging. The battery 296 may include, for example, a rechargeable battery and/or a solar battery.

The indicator 297 may display a particular state (for example, a booting state, a message state, a charging state, or the like) of the electronic device 201 or a part (for example, the processor 210) of the electronic device 201. The motor 298 may convert an electrical signal into a mechanical vibration, and may generate a vibration, a haptic effect, or the like. Although not illustrated, the electronic device 201 may include a processing unit (for example, a GPU) for supporting a mobile television (TV). The processing unit for supporting a mobile TV may, for example, process media data according to a certain standard such as Digital Multimedia Broadcasting (DMB), Digital Video Broadcasting (DVB), or mediaFlo™.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

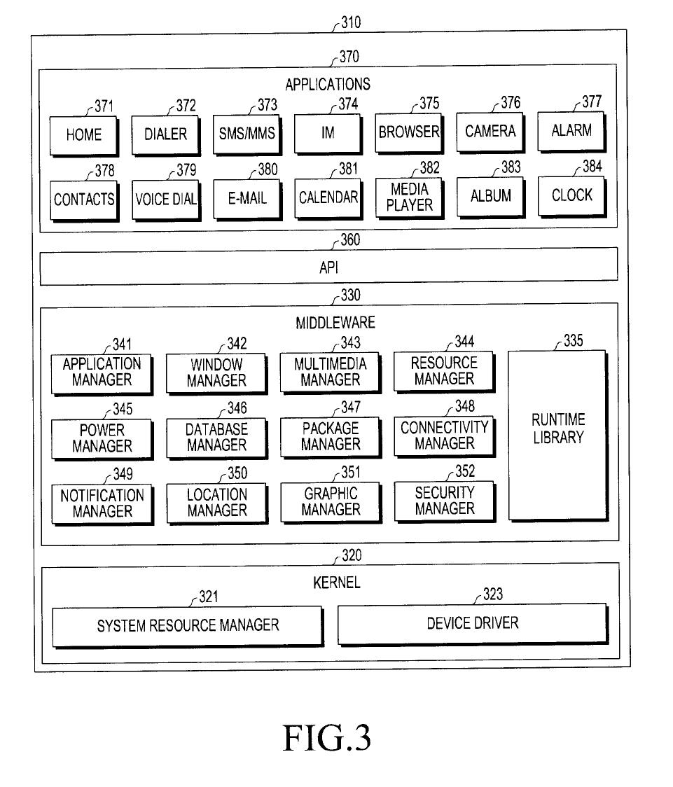

FIG. 3 is a block diagram of an example of a program module, according to various embodiments of the present disclosure. According to an embodiment, a program module 310 (for example, the program 140) may include an Operating System (OS) for controlling resources related to the electronic device (for example, the electronic device 101) and/or various applications (for example, the application programs 147) executed in the operating system. The operating system may be, for example, Android, iOS, Windows, Symbian, Tizen, Bada, or the like.

The program module 310 may include a kernel 320, middleware 330, an Application Programming Interface (API) 360, and/or applications 370. At least some of the program module 310 may be preloaded on the electronic device, or may be downloaded from an external electronic device (for example, the electronic device 102 or 104, or the server 106).

The kernel 320 (for example, the kernel 141) may include, for example, a system resource manager 321 and/or a device driver 323. The system resource manager 321 may perform the control, allocation, collection, or the like of system resources. According to an embodiment, the system resource manager 321 may include a process manager, a memory manager, a file system manager, or the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 330 may provide a function required by the applications 370 in common, or may provide various functions to the applications 370 through the API 360 so that the applications 370 can efficiently use limited system resources within an electronic device. According to an embodiment, the middleware 330 (for example, the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module which a compiler uses in order to add a new function through a programming language while the applications 370 are being executed. The runtime library 335 may perform input/output management, memory management, the functionality for an arithmetic function, or the like.

The application manager 341 may manage, for example, a life cycle of at least one of the applications 370. The window manager 342 may manage Graphical User Interface (GUI) resources used for a screen. The multimedia manager 343 may determine a format required to reproduce various media files, and may encode or decode a media file by using a coder/decoder (codec) that is appropriate for the corresponding format. The resource manager 344 may manage resources, such as a source code, a memory, a storage space, and the like of at least one of the applications 370.

The power manager 345 may operate together with a Basic Input/Output System (BIOS) or the like to manage a battery or power, and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection, such as, for example, Wi-Fi, Bluetooth, or the like. The notification manager 349 may display or notify of an event, such as an arrival message, an appointment, a proximity notification, and the like, in such a manner so as not to disturb the user. The location manager 350 may manage location information of an electronic device. The graphic manager 351 may manage a graphic effect, which is to be provided to the user, or a user interface related to the graphic effect. The security manager 352 may provide various security functions required for system security, user authentication, and the like. According to an embodiment of the present disclosure, when an electronic device (for example, the electronic device 101) has a telephone call function, the middleware 330 may further include a telephony manager for managing a voice call function or a video call function of the electronic device.

The middleware 330 may include a middleware module that forms a combination of various functions of the above-described elements. The middleware 330 may provide a module that is specialized for each type of operating system in order to provide a differentiated function. Also, the middleware 330 may dynamically delete some of the existing elements, or may add new elements.

The API 360 (for example, the API 145) is, for example, a set of API programming functions, and may be provided with a different configuration based on an operating system. For example, in the case of Android or iOS, one API set may be provided for each platform. In the case of Tizen, two or more API sets may be provided for each platform.

The applications 370 (for example, the application programs 147) may include, for example, one or more applications that are capable of providing functions such as home 371, dialer 372, SMS/MMS 373, Instant Message (IM) 374, browser 375, camera 376, alarm 377, contacts 378, voice dial 379, email 380, calendar 381, media player 382, album 383, clock 384, health care (for example, measuring exercise quantity or blood sugar), environment information (for example, atmospheric pressure, humidity, or temperature information), and the like.

According to an embodiment, the applications 370 may include an application (hereinafter, referred to as an “information exchange application” for convenience of description) that supports exchanging information between the electronic device (for example, the electronic device 101) and an external electronic device (for example, the electronic device 102 or 104). The application associated with the exchange of information may include, for example, a notification relay application for transferring specific information to an external electronic device or a device management application for managing an external electronic device.

For example, the notification relay application may include a function of transferring, to the external electronic device (for example, the electronic device 102 or 104), notification information generated from other applications of the electronic device 101 (for example, an SMS/MMS application, an e-mail application, a health management application, or an environmental information application). Further, the notification relay application may receive notification information from, for example, an external electronic device and may provide the received notification information to a user.

The device management application, for example, may manage (for example, install, delete, or update) at least one function of an external electronic device (for example, the electronic device 102 or 104, or the server 106) communicating with the electronic device (for example, a function of turning on/off the external electronic device itself (or some components) or a function of adjusting luminance (or a resolution) of the display), applications operating in the external electronic device, or services provided by the external electronic device (for example, a call service and a message service).

According to an embodiment, the applications 370 may include applications (for example, a health care application of a mobile medical appliance or the like) designated according to attributes of an external electronic device 102 or 104. According to an embodiment, the applications 370 may include an application received from an external electronic device (for example, the server 106, or the electronic device 102 or 104). According to an embodiment, the applications 370 may include a preloaded application or a third party application, which may be downloaded from a server. Names of the elements of the program module 310, according to the above-described embodiments of the present disclosure, may change depending on the type of OS.

According to various exemplary embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least a part of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added. Various embodiments disclosed herein are provided merely to easily describe technical details of the present disclosure and to help the understanding of the present disclosure, and are not intended to limit the scope of the present disclosure. Accordingly, the scope of the present disclosure should be construed as including all modifications or various other embodiments based on the technical idea of the present disclosure.

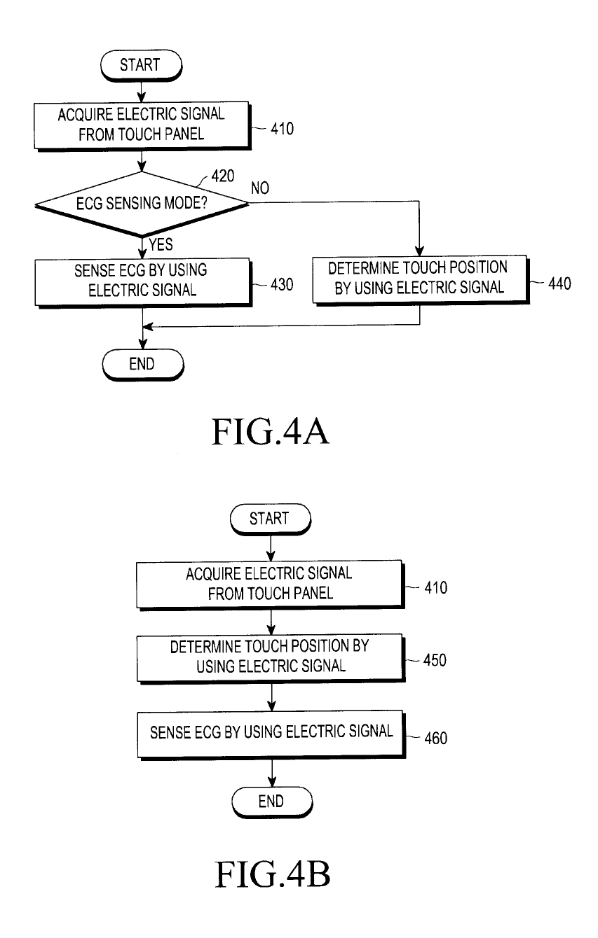

FIG. 4A is a flowchart of an example of a process, according to various embodiments.

In operation 410, the electronic device 101 may acquire an electric signal from the touch panel. For example, the touch panel may include a plurality of electrodes. The plurality of electrodes may output electric signals by a change in an electric field around the plurality of electrodes, and the electronic device 101 may acquire the electric signals from the plurality of electrodes of the touch panel.

According to various embodiments, the touch panel may acquire electric signals in two situations. In the first situation, a first electrode of the touch panel is configured as a transmission electrode and a second electrode is configured as a reception electrode and thus the first electronic device transmits an electric field. The second electrode corresponding to the reception electrode may output an electric signal by the electric field from the first electrode. In this case, the second electrode may output, for example, an electric signal having a voltage of a. For example, when a user's finger is located in proximity to the second electronic device, the finger may absorb some of the electric field from the first electrode. The second electrode may output, for example, an electric signal having a voltage of b by the remaining electric field except for some of the electric field absorbed into the finger. The electronic device 101 may determine a touch position according to a difference between the electric signals.

In the second situation, electrodes of the touch panel may output electric signals by an electric field from a user's body. In the user's body, a zero potential line having a potential of 0 may be generated while crossing the heart, and a potential having a positive value may be formed on one side of the zero potential line and a potential having a negative value may be formed on the other side of the zero potential line. Accordingly, the potential, that is, the electric field may be formed on the end of the user's body, for example, a finger. The electrodes of the touch panel of the electronic device 101 may output electric signals by the electric field formed on the finger.

As described above, the electrodes of the touch panel may output electric signals by the electric field of the transmission electrode or the electric field of the user's body. The electronic device 101 according to the various embodiments may acquire electric signals output from the touch panel through the aforementioned various methods.

In operation 420, the electronic device 101 may detect whether an operation mode is an ECG sensing mode. According to an embodiment, the electronic device 101 may determine the operation mode based on a user's input. For example, the electronic device 101 may determine the operation mode to be the ECG sensing mode based on the user's input. Alternatively, the electronic device 101 may determine the operation mode to be a touch position determination mode based on a user's input.

According to another embodiment, the electronic device 101 may determine the operation mode by itself based on at least one of a touch time and a touch pressure of the detected touch. For example, when at least one of the touch time and the touch pressure of the touch is equal to or smaller than a threshold, the electronic device 101 may determine the operation mode to be the touch position determination mode. Alternatively, when at least one of the touch time and the touch pressure of the touch is larger than the threshold, the electronic device 101 may determine the operation mode to be the ECG sensing mode.

According to another embodiment, when the touch pressure is larger than a preset threshold, the electronic device 101 may determine the operation mode to be the ECG sensing mode. The electronic device 101 may determine the ECG sensing mode by using both the touch time and the touch pressure.

According to another embodiment, when a potential difference of electric signals from a plurality of detected touches is equal to or smaller than a threshold, the electronic device 101 may determine the operation mode to be the touch position determination mode. Alternatively, when the potential difference of the electric signals from the plurality of detected touches is larger than or equal to the threshold, the electronic device 101 may determine the operation mode to be the ECG sensing mode.

When the operation mode is the ECG sensing mode, the electronic device 101 may sense the ECG by using the electric signals from the touch panel in operation 430. For example, the electronic device 101 may acquire electric signals from at least two areas of the touch panel. For example, the electronic device 101 may acquire a first electric signal from a first area of the touch panel and acquire a second electric signal from a second area of the touch panel. The first area is an area corresponding to a first touch and may correspond to one or more channels of the touch panel, and the second area is an area corresponding to a second touch and may correspond to one or more channels of the touch panel. The electronic device 101 may sense the ECG based on a potential difference of the first electric signal and the second electric signal. As described above, both hands of the user's body may have potentials of different poles. Accordingly, the first electric signal output by the potential of one hand of the user and the second electric signal output by the potential of the other hand of the user may be different from each other. Further, each of the first electric signal and the second electric signal may vary depending on time according to activities of the heart. The electronic device 101 may sense the ECG corresponding to the activities of the heart based on the difference between the first electric signal and the second electric signal.

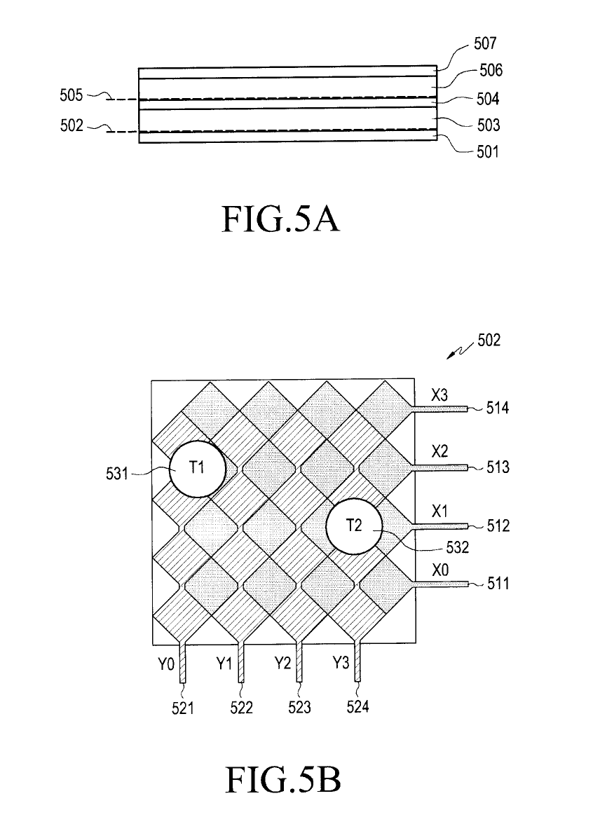

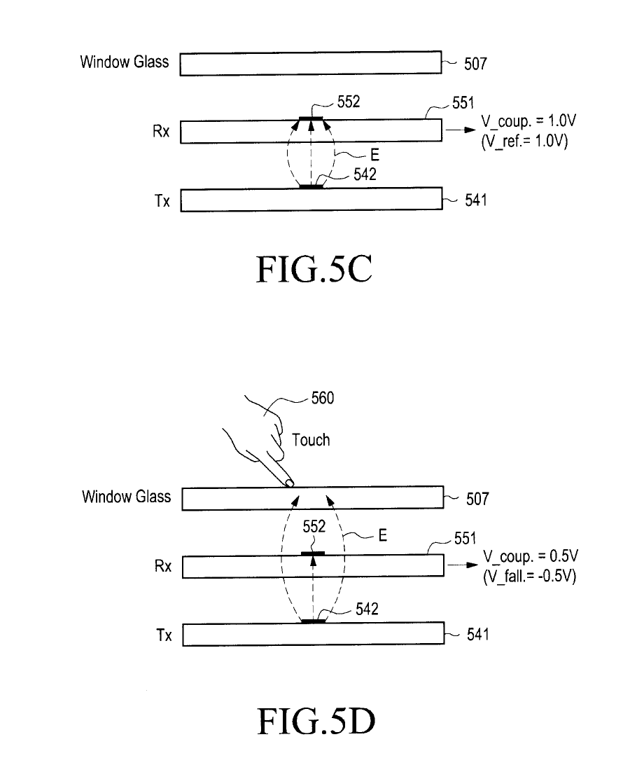

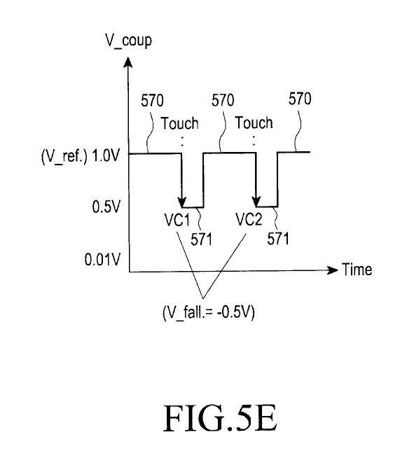

When the operation mode is the touch position determination mode, the electronic device 101 may determine a touch position on the touch panel by using the electric signals from the touch panel in operation 440. As described above, the electronic device 101 may determine the touch position based on the electric signal from each electrode, which will be described with reference to FIGS. 5A to 5E.

In the above description, the electronic device 101 may first determine the operation mode, and then sense the ECG or determine the touch position by using the electric signals according to the determined operation mode. When the electronic device 101 senses the ECG, the electronic device 101 may release a connection between a circuit for determining the touch position, for example, a driver for scanning and the touch panel. When the electronic device 101 may determine the touch position, the electronic device 101 may release a connection between a circuit for sensing the ECG and the touch panel.

FIG. 4B is a flowchart of an example of a process, according to various embodiments. As described above, when the electronic device 101 of FIG. 4A may sense the ECG or determine the touch position, the electronic device 101 of FIG. 4B may simultaneously perform the sensing of the ECG and the determination of the touch position.

In operation 410, the electronic device 101 may acquire electric signals from the touch panel.

In operation 450, the electronic device 101 may sense an ECG by using the electric signals. In operation 460, the electronic device 101 may sense the ECG and determine a touch position by using the electric signals at the same time.

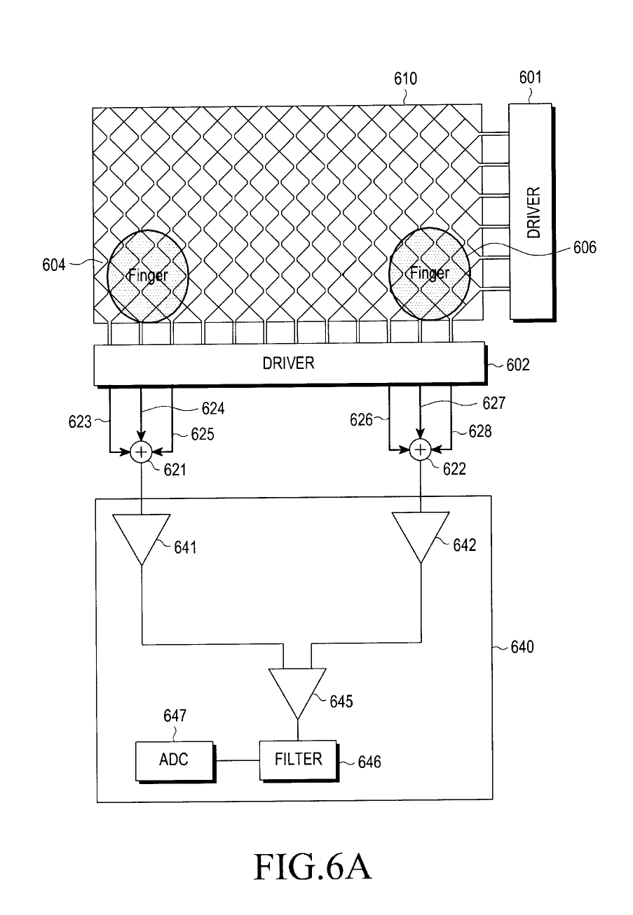

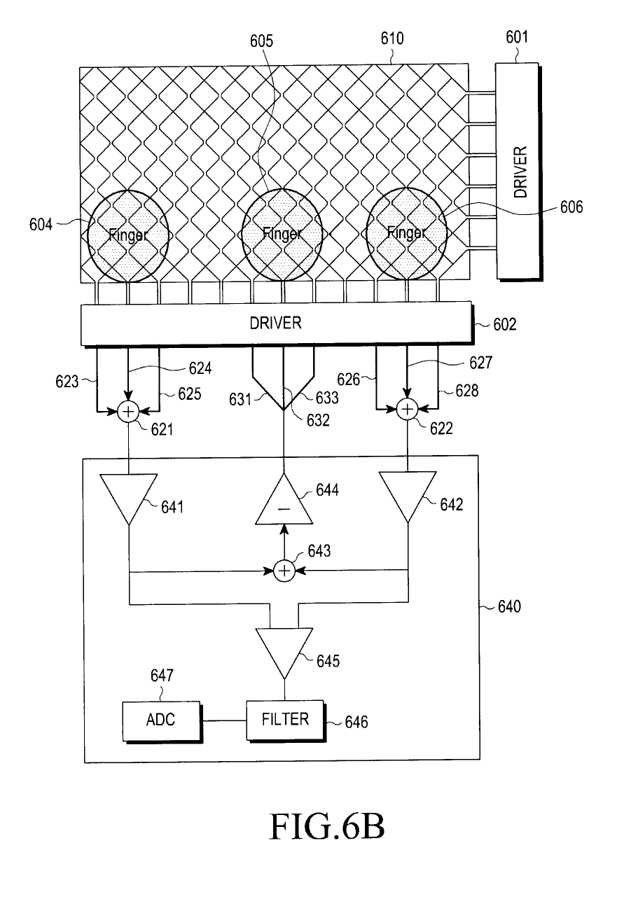

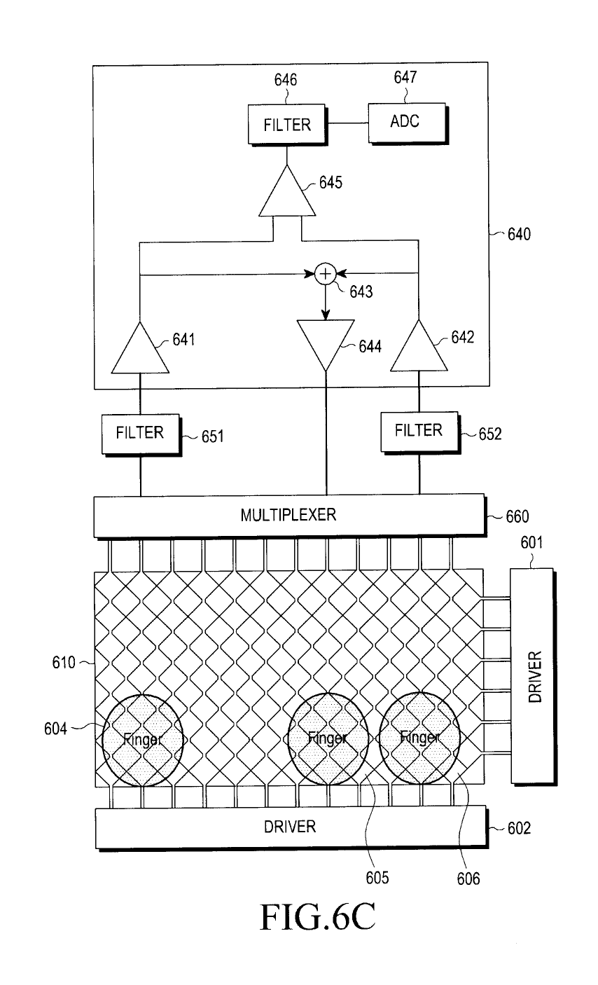

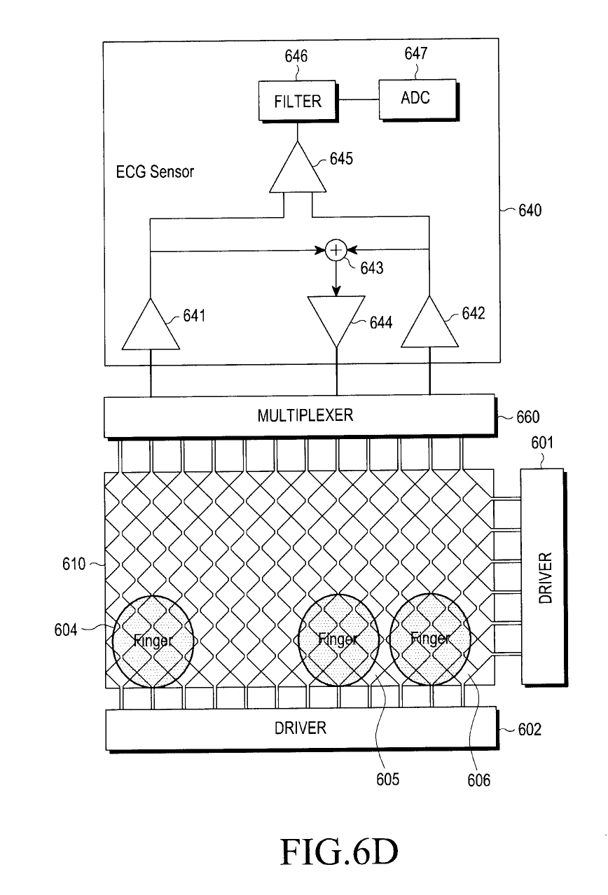

The electronic device 101 may sense the ECG by using a component of a first frequency band among electric signals generated from the touch panel. The electronic device 101 may determine the touch position by using a component of a second frequency band among the electric signals generated from the touch panel. For example, the ECG may be a relatively low frequency band, and an electric field generated from a transmission electrode of the touch panel may be a relatively high frequency band. Accordingly, the electronic device 101 may sense the ECG by using the component of the first frequency band which is the relatively low frequency band of the electric signal. Further, the electronic device 101 may determine the touch position by using the component of the second frequency band which is the relatively high frequency band of the electric signal. The electronic device 101 may use the frequency band through a filter, which will be described with reference to FIG. 6C.

According to the above description, the electronic device 101 may sense the ECG and use the sensed ECG for an authentication process. The electronic device 101 may perform an application execution operation including the authentication process according to an authentication result. Alternatively, the electronic device 101 may use the sensed ECG for a game control. For example, the electronic device 101 may execute a game or interwork with a console game machine to perform an authentication and then load a profile of the corresponding user in the electronic device 101. In this case, the electronic device 101 may perform a user authentication by using the ECG. Further, the electronic device 101 may continuously determine a user's biometric information, for example, emotion, excitement, and stress by using the ECG. The electronic device 101 may provide a function related to the game by using the determined biometric information. The electronic device 101 may provide relevant functions such as a level of difficulty of the game, a skipping of an event, an interruption of the game, and a reward. The level of difficulty may include, through a change in a parameter, the type or number of characters appearing, attributes of weapons (type, firepower, speed, power, type, number of bullets), attributes of characters (strength, mana, speed, agility, degree of direct hit, vital power, offense power, and defense power), the number of enemies, firepower of enemies, the type of weapons, the number of weapons, and power of weapons. The reward may include providing a medal, upgrading a weapon, and providing an item, a wallpaper, and an avatar. Meanwhile, the electronic device 101 may interrupt the game or provide a notification or an alarm to another person when the biometric information is abnormal.

The electronic device 101 may transmit biometric information to another electronic device, for example, a TV, and the other electronic device 101 may display the biometric information, combine the biometric information with a required exercise guide, for example, a heart rate, an HRV, and weather information, and recommend a proper indoor exercise. Alternatively, after the user authentication, the electronic device 101 may transmit a last setting value used by the corresponding user to another electronic device to allow the other electronic device to use the last setting value. Alternatively, the electronic device 101 may operate based on history information on the corresponding user after the user authentication. For example, the electronic device 101 may automatically connect to a preferred channel at a particular time, play a next episode of a preferred soap opera, turn down a volume or change a channel during an advertisement, and perform a Picture-In-Picture (PIP) operation.

FIG. 5A is a diagram of an example of an electronic device, according to various embodiments. As illustrated in FIG. 5A, the electronic device 101 may include a first film layer 501, a first electrode layer 502, a first adhesive layer 503, a second film layer 504, a second electrode layer 505, a second adhesive layer 506, and a window glass layer 507.

According to various embodiments, the first electrode layer 502 may be disposed on the first film layer 501. The first adhesive layer 503 may be disposed on the first electrode layer 502. The second film layer 504 may be disposed on the first adhesive layer 503. The second electrode layer 505 may be disposed on the second film layer 504. The second adhesive layer 506 may be disposed on the second electrode layer 505. The window glass layer 507 may be disposed on the second adhesive layer 506.

The first film layer 501 and the second film layer 504 may include, for example, Indium Tin Oxide (ITO). The first film layer 501 and the second film layer 504 may be a thin film, which constitute a transparent electrode, as a compound of indium and tin oxide. The first adhesive layer 503 and the second adhesive layer 506 may include an Optical Clear Adhesive (OCA). For example, the first adhesive layer 503 and the second adhesive layer 506 may be a transparent double-sided tape for sticking elements together disposed above and below. A transmitter electrode for transmitting a pulse signal for detecting a touch signal may be formed on a contact surface of the first film layer 501, which contacts the first adhesive layer 503. For example, the first electrode layer 502 may be formed in a transverse direction. A receiver electrode for receiving the pulse signal may be formed on a contact surface of the second film layer 504, which contacts the second adhesive layer 506. For example, the second electrode 505 may be formed in a longitudinal direction.

For example, as illustrated in FIG. 5B, when the user touches a location T1 531 with a finger, the capacitive type touch panel of 4×4 sensors may detect a change in a measurement signal received by the reception electrode corresponding to coordinates (X2, Y0) of the location T1. When the user touches a location T2 532, a change in a measurement signal received by the reception electrode corresponding to coordinates (X1, Y3) of the location T2 may be detected. As illustrated in FIG. 5B, the electronic device 101 may include x channels 511 to 514 and y channels 521 to 524 and may determine a location of the touch based on an electric signal output from each channel.

Referring to FIG. 5C, a transmission electrode 542 of the first electrode 541 of the touch panel may emit electric fields. According to an embodiment, the electronic device 101 may apply a current to the transmission electrode 542, and the transmission electrode 542 may emit the electric fields 543, 544, and 545 based on the applied current.

A reception electrode 552 of a second electrode 551 of the touch panel may receive an electric field (E) from the transmission electrode 542. The reception electrode 552 may be an electrode connected to the processor by the driver during a scanning period. A plurality of electrodes included in the second electrode 551 may be connected to the processor by the driver during scanning periods thereof.

In this case, the reception electrode 552 may output an electric signal based on the received electric field (E). For example, as illustrated in FIG. 5E, the reception electrode 552 may output an electric signal having a first size 570. The electronic device 101 may determine that the touch is not input with respect to a channel into which the electric signal having the first size 570 is input.

Meanwhile, referring to FIG. 5D, a user's body 560 may be located near the reception electrode 552. In this case, some of the electric field (E) from the transmission electrode 542 may be absorbed into the user's body 560 and only some of the remaining electric field may be received by the reception electrode 552. Accordingly, the reception electrode 552 near the user's body 560 may receive an electric field having a relatively smaller size compared to the reception electrode having no user's body near it. Accordingly, as illustrated in FIG. 5E, the reception electrode 552 may output an electric field having a second size 571. The electronic device 101 may determine that the touch is input with respect to a channel into which the electric signal having the second size 571 is input. Meanwhile, the size of a voltage of the electric signal may be measured in the unit of coupling voltages of the touch panel as illustrated in FIG. 5E. The coupling voltage may be a voltage generated in the reception electrode 552 by the pulse signal transmitted from the transmission electrode 542.

In the touch position determination mode, the electronic device 101 according to various embodiments may determine a touch position through the above described process. In this case, the electronic device 101 may release an electric connection to make a processing module for the ECG sensing separated from the touch panel. Alternatively, the electronic device 101 may connect the processing module for the ECG sensing to the touch panel and perform the determination of the touch position and the ECG sensing at the same time.

FIG. 6A is a diagram of an example of an electronic device, according to various embodiments. As illustrated, one or more drivers 601 and 602 may be connected to a touch panel 610. The one or more drivers 601 and 602 may scan at least one channel of the touch panel 610. The one or more drivers 601 and 602 may connect at least one channel of the touch panel 610 to the processor 120, and the processor 120 may determine a touch position by using an electric signal output from each channel. That is, the touch panel 610 may be connected to the processor 120 through the drivers 601 and 602 or through a processing module 640.

The processing module 640 may be connected to the touch panel 610. As illustrated in FIG. 6A, the processing module 640 may be connected to the touch panel 610 through detour routes 623, 624, 625, 626, 627, and 628. The detour routes 623, 624, 625, 626, 627, and 628 may connect the touch panel 610 and the processing module 640 without passing through the one or more drivers 601 and 602.

For example, the detour routes 623, 624, and 625 may connect three channels of the touch panel 610 to the processing module 640. The processing module 640 may be connected to the one or more channels of the touch panel 610. This is for securing a sufficient measurement area for the ECG sensing. Further, the detour routes 626, 627, and 628 may connect three channels of the touch panel 610 to the processing module 640. The part of the touch panel connected to the detour routes 623, 624, and 625 may be named a first area 604, and the part of the touch panel connected to the detour routes 626, 627, and 628 may be named a second area 606. As described above, the ECG may be measured based on the potential difference of the electric field from the left finger included in one side based on the center of the zero potential line of the human body and the electric field from the right finger included in the other side of the zero potential line based on the center of the zero potential line of the human body. Accordingly, the electronic device 101 may sense the ECG by using the potential difference of the electric signals from the two areas 604 and 606.

For example, the electric signals from the detour routes 623, 624, and 625 corresponding to the first area 604 may be added by an adder 621. Further, the electric signals from the detour routes 626, 627, and 628 corresponding to the second area 606 may be added by an adder 622. The signal added by the adder 621 may correspond to the first area 604 and the signal added by the adder 622 may correspond to the second area 606. Meanwhile, an AMP 641 may amplify the signal added by the adder 621 with a preset gain, and an AMP 642 may amplify the signal added by the adder 622 with a preset gain. A differential amplifier 645 may output a potential difference of the two signals. A filter 646 may allow the output potential difference to pass through a frequency band corresponding to the ECG, and an ADC 647 may convert the potential difference from the filter 646 into a digital signal. The processor 120 may sense the ECG based on the potential difference converted into the digital signal.

Meanwhile, the electronic device 101 may display screens corresponding to the first area 604 and the second area 606. The user may touch the first area 604 with a left hand and the second area 606 with a right hand. The electronic device 101 may sense the ECG based on a potential difference of the electric signal from the left hand and the electric signal from the right hand. Alternatively, the electronic device 101 may determine the potential difference through a change in a difference between capacitance corresponding to the first area 604 and capacitance corresponding to the second area 606 and sense the ECG.

As described above, the electronic device 101 according to various embodiments may connect the one or more drivers 601 and 602 for the determination of the touch position to the touch panel 610, and also connect the processing module 640 for the ECG sensing to the touch panel 610. For example, when the ECG sensing is performed, the electronic device 101 may make a control to connect the processing module 640 of the ECG sensing to the touch panel 610 and may release a connection between the touch panel 610 and the drivers 601 and 602. Alternatively, when the touch position is determined, the electronic device 101 may make a control to not connect the processing module 640 for the ECG sensing to the touch panel 610 while connecting the touch panel 610 and the drivers 601 and 602. As the processing module 640 and the touch panel 610 of the electronic device 101 according to various embodiments are connected through the detour routes without passing through the drivers 601 and 602, the signals in two operation modes may be separated. Meanwhile, although it has been illustrated that the channels correspond to one area in the embodiment of FIG. 6A, the number of channels is not limited.

FIG. 6B is a diagram of an example of an electronic device, according to various embodiments. As illustrated, the electronic device 101 may further include an adder 643, an inverter AMP 644, and detour routes 631, 632, and 633 compared to FIG. 6A. The electronic device 101 according to various embodiments may extract common mode noise from the signals corresponding to the first area 604 and the signals corresponding to the second area 606. The adder 643 may add the extracted common mode noise and output the added common mode noise. The inverter AMP 644 may receive the common mode noise and output an inverse phase signal. The inverse phase signal may be input into channels corresponding to a third area 605 of the touch panel 610 through the detour routes 631, 632, and 633. When the user touches the third area 605, the inverse phase signal may flow in the user's body. Accordingly, the common mode noise within the body, which is measured when the ECG is sensed, may be offset. The electronic device 101 according to various embodiments may display a screen corresponding to the third area 605. The user may touch the first area 604, the second area 606, and the third area 605 with corresponding fingers according to the displayed screen.

FIG. 6C is a diagram of an example of an electronic device, according to various embodiments. As illustrated, the electronic device 101 may include the touch panel 610, the one or more drivers 601 and 602, the processing module 640, one or more filters 651 and 652, and a multiplexer 660.

The one or more drivers 601 and 602 may be connected to the touch panel 610. As described above, the electronic device 101 according to various embodiments may scan for each channel of the touch panel 610 by controlling the one or more drivers 601 and 602. The electronic device 101 may determine a touch position by using a result of the scanning. As described above, the electronic device 101 may generate an electric field by applying a current to the transmission electrode and determine the touch position by using an electric signal received by the reception electrode. In such instances, the current applied to the transmission electrode and the electric signal received by the reception electrode may have a second frequency band. The second frequency band may be a relatively high frequency compared to the electric signal for the ECG sensing, and the frequency band of the electric signal for the ECG sensing may be named a first frequency band.

The filters 651 and 652 may filter the signal of the second frequency band and allow the signal of the first frequency band to pass therethrough to make the signal of the first frequency band reach the processing module 640. That is, the filters 651 and 652 allow only the electric signal for the ECG sensing to pass therethrough, so that the electronic device 101 may sense the ECG with the signal of the first frequency band and determine the touch position with the signal of the second frequency band at the same time.

The multiplexer 660 may control a connection between at least one area of the touch panel and the processing module 640, which will be described in more detail with reference to FIG. 6D.

The processing module 640 may include an AMP 641 for amplifying the signal corresponding to the first area 604, which is input from the filter 651 and an AMP 642 for amplifying the signal corresponding to the second area 606, which is input from the filter 652. As described in FIG. 6A, the differential amplifier 645 may output the potential difference of the signal corresponding to the first area 604 and the signal corresponding to the second area 606, and the filter 646 may filter the potential difference and output the filtered potential difference to the ADC 647. The ADC 647 may convert the potential difference into a digital signal and output the digital signal, and the processor 120 may sense the ECG by using the potential difference. Further, the electronic device 101 may extract common mode noise from the first area 604 and the second area 606, and the adder 643 may add the common mode noise. The inverter AMP 644 may output an inverse phase signal of the common mode noise, and the electronic device 101 may output the inverse phase signal to the channel corresponding to the third area 605 of the touch panel. The user may touch the first area 604 and the second area 606 with both hands, respectively, and additionally touch the third area 605 with a finger of one of the hands. The electronic device 101 may display a screen, which requires a proper finger, on the display. As described above, the electronic device 101 according to various embodiments may separately process the electric signal of the first frequency band and the electric signal of the second frequency band, so as to simultaneously perform the ECG sensing and the determination of the touch position. Meanwhile, although it has been illustrated that the number of channels corresponding to each of the areas 604, 605, and 606 is one in the embodiment of FIG. 6C, the number of channels is not limited.

FIG. 6D is a diagram of an example of an electronic device, according to various embodiments. Although it is illustrated that the electronic device 101 does not include the filters 651 and 652 in the embodiment of FIG. 6D, it is only an example and the electronic device 101 according to various embodiments may include all of the filters 651 and 652, and the multiplexer 660.

The multiplexer 660 may connect channels of the touch panel to the processing module 640. For example, on the touch panel, the first area 604, the second area 606, and the third area 605 for the ECG sensing may be configured. The electronic device 101 may pre-configure the first area 604, the second area 606, and the third area 605, and may display a screen for inducing a touch of each of the first area 604, the second area 606, and the third area 605. The multiplexer 660 may connect the channel corresponding to each of the first area 604, the second area 606, and the third area 605 to the processing module 640.

According to various embodiments, the electronic device 101 may change locations of the first area 604, the second area 606, and the third area 605. The multiplexer 660 may connect, to the processing module 640, the channels corresponding to the first area 604, the second area 606, and the third area 605 of which the locations are changed. Accordingly, the electronic device 101 may freely configure areas for the ECG sensing on the touch panel. Further, in the touch position determination mode, the electronic device 101 may control the multiplexer 660 to separate the touch panel 610 from the processing module 640.

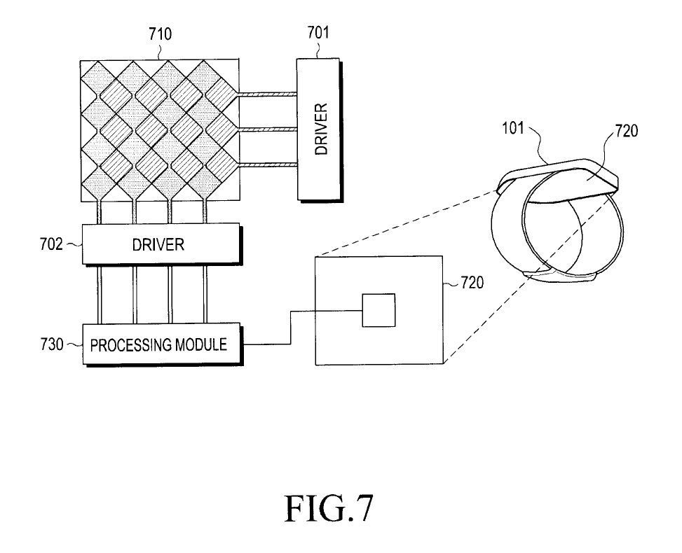

FIG. 7 is a diagram of an example of an electronic device, according to various embodiments.

As illustrated in FIG. 7, the electronic device 101 may be implemented as, for example, a wrist watch type wearable electronic device. A touch panel 720 may be disposed on the rear surface of the body of the electronic device 101. When the touch panel 720 is disposed on the rear surface, the touch panel 720 may be implemented with a material, which is not transparent. A processor 730 may acquire a first electric signal from the touch panel 720. For example, when the user wears the electronic device 101 on a left hand, the first electric signal corresponding to the left side of the user's body may be output from the touch panel 720.

Meanwhile, the electronic device 101 may include a touch panel 710 disposed on the front surface of the body of the electronic device 101. The touch panel 710 may be implemented with, for example, a transparent material including ITO. Further, at least one channel of the touch panel 710 may be scanned for by one or more drivers 701 and 702.

The processor 730 may determine a touch position on the touch panel 710 by using a result of the scan. Meanwhile, the user may touch one position of the touch panel 710 with the right hand and, in this case, the processor 730 may acquire a second electric signal for the ECG sensing. The processor 730 may sense the ECG based on a potential difference of the second electric signal from the touch panel 710 and the first electric signal from the touch panel 720. According to the above description, the user may not touch the touch panel 710 with both hands for the ECG sensing. Although the user touches the touch panel 710 with only one hand, the electronic device 101 may sense the ECG based on the electric signal from the touch panel 720 on the rear surface. Accordingly, the electronic device 101 may sense the seamless ECG whenever the user touches the touch panel 710.

According to various embodiments of the present disclosure, the electronic device 101 may use the ECG sensing for a user authentication. For example, the electronic device 101 may display an interface for the ECG sensing and induce the user to make an input. According to another embodiment, the electronic device 101 may operate an application for the ECG sensing only in the background without separately displaying the interface for the ECG sensing, and may perform the ECG sensing or the user authentication when the user touches the electronic device 101 without recognition.

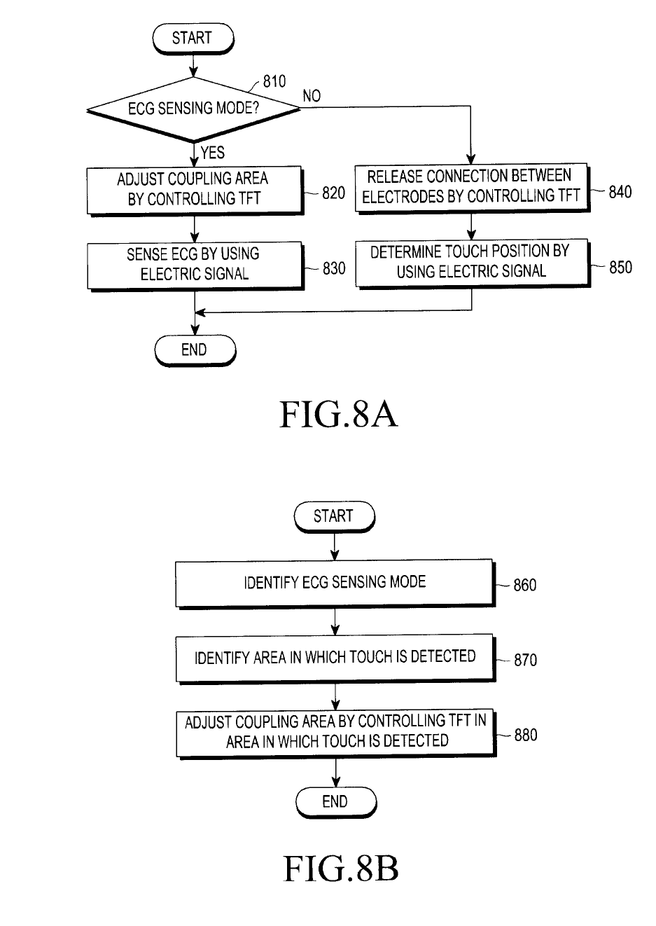

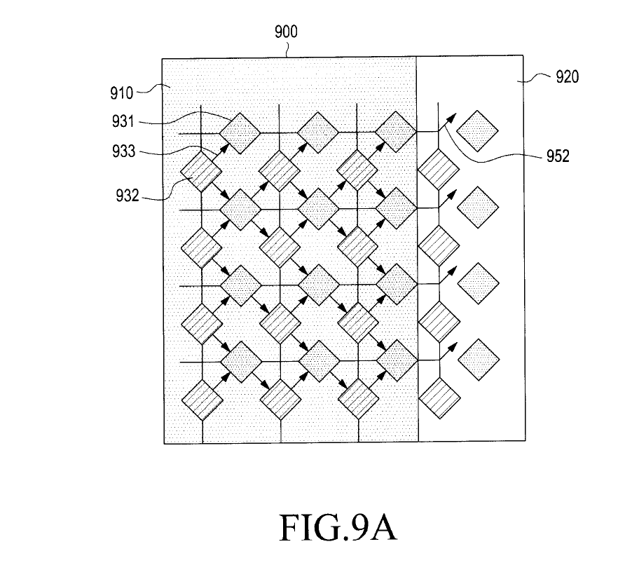

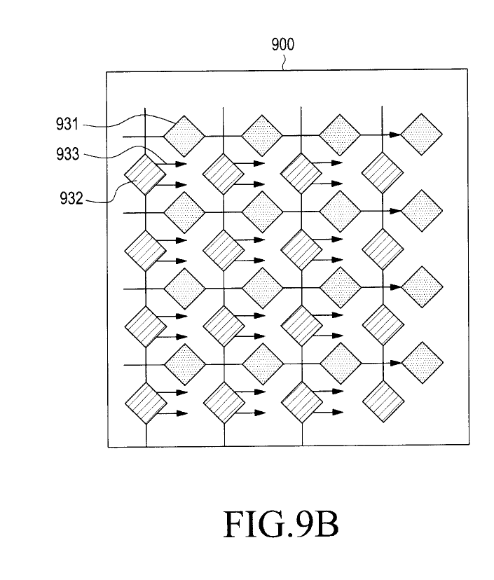

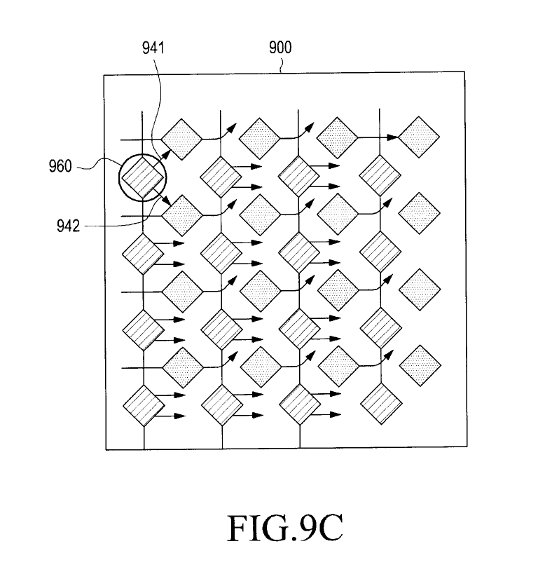

FIGS. 8A-B are flowcharts of examples of different processes, according to various embodiments. FIGS. 8A-B are described with reference to FIGS. 9A-C. FIG. 9A-C are diagrams illustrating example(s) a Thin Film Transistor (TFT), according to various embodiments.

Referring first to FIG. 8A, the electronic device 101 may determine whether an operation mode is an ECG sensing mode in operation 810. In the ECG sensing mode, the electronic device 101 may adjust a coupling area by controlling a TFT in operation 820. For example, the electronic device 101 may include a touch panel 900 in which electrodes can be connected through the TFT as illustrated in FIG. 9A. The touch panel 900 may include one or more electrodes 931 and 932. The electronic device 101 may make a control to connect the one or more electrodes 931 and 932 or to release the connection through a TFT 933. Accordingly, the electronic device 101 may adjust the coupling area for acquiring electric signals for the ECG sensing from a user's touch. For example, in the embodiment of FIG. 9A, the electronic device 101 may make a control to connect the electrodes 931 and 932 of a first area 910 for the ECG sensing to each other through the TFT 933. In a similar way, the remaining electrodes of the first area 910 may be connected to each other through the TFTs. Further, the electronic device 101 may make a control to not connect electrodes to each other in a second area 920. The electronic device 101 may make a control to not connect TFTs 952 between the first area 910 and the second area 920. When the position of the first area 910 for the ECG sensing is changed, the electronic device 101 may connect electrodes corresponding to the changed position through TFTs. In operation 830, the electronic device 101 may perform the ECG sensing by using electric signals from the first area 910.

In the touch position determination mode, the electronic device 101 may release the connection between the electrodes by controlling the TFT. For example, as illustrated in FIG. 9B, the electronic device 101 may make a control to not connect TFTs 933 between the electrodes 931 and 932. Further, the first area 910 and the second area 920 of FIG. 9A may be connected to each other. In operation 850, the electronic device 101 may determine a touch position by using electric signals from the touch panel 900.

As described above, the electronic device 101 may control the coupling area according to whether the ECG is sensed or touch position is determined. The electronic device 101 may control the coupling area to be relatively large in order to relatively increase a signal strength when the ECG is sensed and may control the coupling area to be relatively small in order to determine a more accurate position when the touch position is determined.

Referring to FIG. 8B, the electronic device 101 may identify the ECG sensing mode in operation 860. In operation 870, the electronic device 101 may first identify an area in which the touch is detected. According to various embodiments, the electronic device 101 may determine the touch position at the same time even in the ECG sensing mode. According to another embodiment, the electronic device 101 may first identify the area in which the touch is detected and then connect the processing module for the ECG sensing to the touch panel.

In operation 880, the electronic device 101 may adjust the coupling area by controlling the TFT in the area in which the touch is detected. For example, referring to FIG. 9C, the electronic device 101 may determine a touch position 960. The electronic device 101 may make a control to connect the electrode 932 corresponding to the touch position 960 to the neighboring electrode 931 through TFTs 941 and 942.

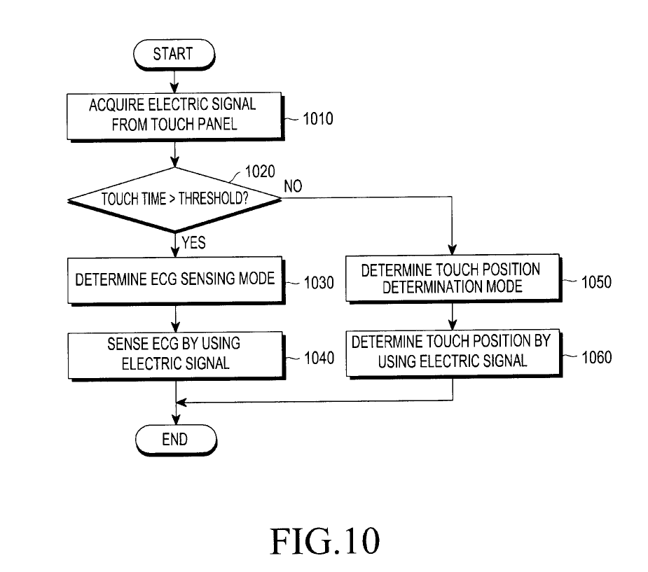

FIG. 10 is a flowchart of an example of a process, according to various embodiments. FIG. 10 may be a flowchart illustrating a method of determining one of the ECG sensing mode and the touch position determination mode by the electronic device 101.

In operation 1010, the electronic device 101 may acquire electric signals from the touch panel. Before determining one of the ECG sensing mode and the touch position determination mode, the electronic device 101 may operate in the touch position determination mode, operate in the ECG sensing mode, or simultaneously perform the ECG sensing and the touch position determination. The user may touch a plurality of areas on the touch panel. The touch panel may output electric signals corresponding to touch inputs.

In operation 1020, the electronic device 101 may determine whether a touch contact time is longer than a preset threshold. When the touch contact time is longer than the preset threshold, the electronic device 101 may determine the operation mode as the ECG sensing mode in operation 1030. In operation 1040, the electronic device 101 may perform the ECG sensing by using the electric signal from the touch panel.

When the touch contact time is equal to or shorter than the preset threshold, the electronic device 101 may determine the operation mode as the touch position determination mode in operation 1050. In operation 1060, the electronic device 101 may determine a touch position by using the electric signal.

For the ECG sensing, a predetermined time for the sensing is required. Accordingly, the electronic device 101 may determine whether the user's intention corresponds to the ECG sensing or the touch according to whether the touch time is longer than the threshold.

Meanwhile, according to another embodiment, the electronic device 101 may determine the operation mode according to the number of touch positions. For example, when the number of areas corresponding to the touch position is one, the electronic device 101 may determine the operation mode as the touch position determination mode.

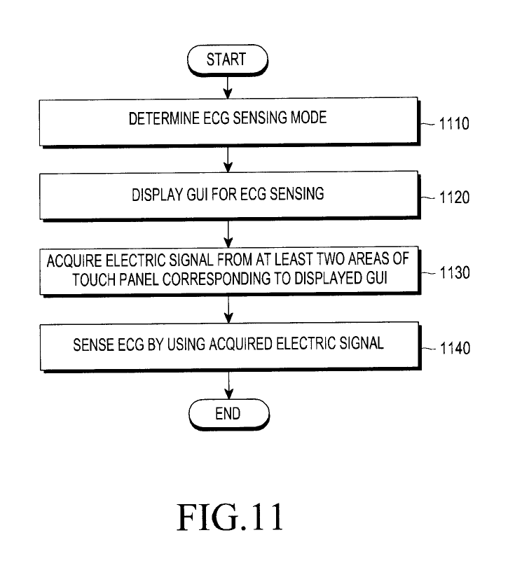

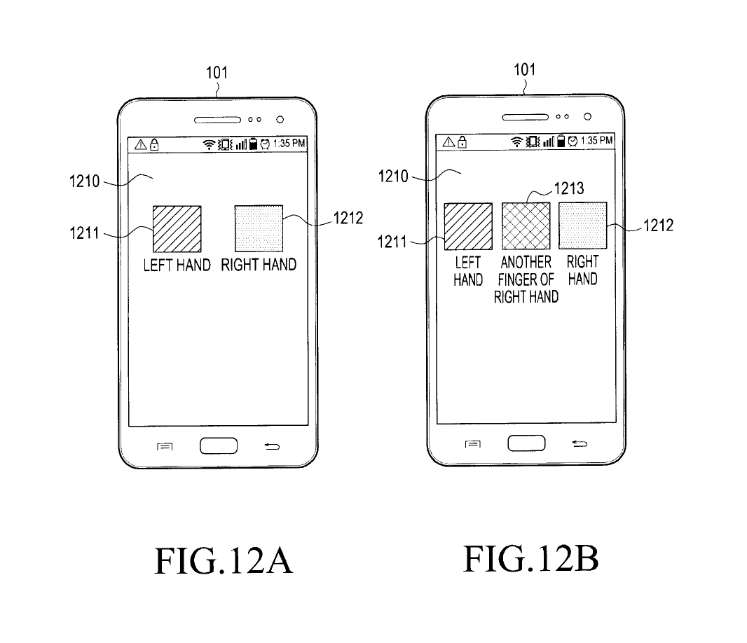

FIG. 11 is a flowchart of an example of a process, according to various embodiments. FIG. 11 may be a flowchart illustrating the operation of the electronic device 101 when the electronic device 101 is in the ECG sensing mode. The embodiment of FIG. 11 will be described with reference to FIGS. 12A-B. FIGS. 12A-B are diagrams of example(s) of an electronic device, according to various embodiments.

In operation 1110, the electronic device 101 may determine the operation mode as the ECG sensing mode.

In operation 1120, the electronic device 101 may display a Graphic User Interface (GUI) for the ECG sensing. According to various embodiments, the electronic device 101 may display a GUI 1210 illustrated in FIG. 12A. As described above, for the ECG sensing, the electronic device 101 may use an electric signal from the hand of one side of the zero potential line and an electric signal from the hand of the other side of the zero potential line. Accordingly, the electronic device 101 may acquire electric signals from at two or more areas of the touch panel and display parts 1211 and 1212 corresponding to the two or more areas. The first part 1211 and the second part 1212 may correspond to, for example, the first area 604 and the second area 606 of the touch panel 610 of FIG. 6A, respectively.

The electronic device 101 may further display a message indicating fingers to touch the two parts 1211 and 1212 of the GUI 1210. For example, as illustrated in FIG. 12A, the electronic device 101 may further display a message for instructing the user to touch the first part 1211 with the left hand and the second part 1212 with the right hand.

In operation 1130, the electronic device 101 may acquire electric signals from the two or more areas of the touch panel corresponding to the displayed GUI 1210. In operation 1140, the electronic device 101 may sense the ECG by using the acquired electric signals.

According to various embodiments, the electronic device 101 may output an inverse phase signal of the common mode noise in the third area 605, which is the additional area for removing noise, like in the embodiment of FIG. 6B. As described with reference to FIG. 6B, the common mode noise may be removed by the inverse phase signal input into the user's body from the third area 605. The electronic device 101 may further display a third part 1213 corresponding to the third area 605 for removing the common mode noise as illustrated in FIG. 12B. In addition, the electronic device 101 may further display information on a finger to touch the third part 1213 for removing the common mode noise.

Meanwhile, as described above, the electronic device 101 may change the area on the touch panel for the ECG sensing, and change and display the GUI in accordance with the change in the area on the touch panel.

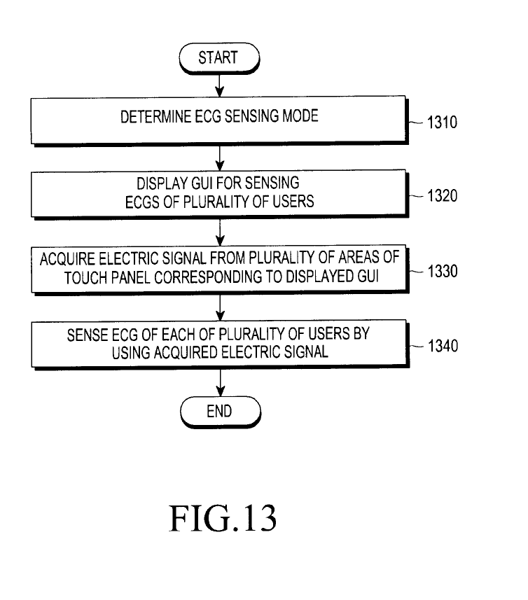

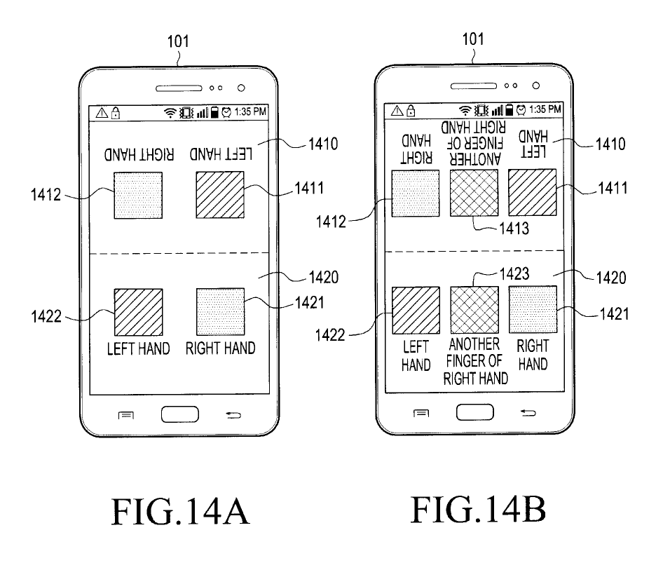

FIG. 13 is a flowchart of an example of a process, according to various embodiments. The embodiment of FIG. 13 will be described with reference to FIGS. 14A-B. FIGS. 14A-B are diagrams of example(s) of an electronic device, according to various embodiments.

In operation 1310, the electronic device 101 may determine the ECG sensing mode as the operation mode.

In operation 1320, the electronic device 101 may display a GUI for sensing ECGs of a plurality of users. For example, the electronic device 101 may display a GUI 1410 and 1420 illustrated in FIG. 14A. The GUI according to various embodiments may include a GUI 1410 for sensing the ECG of a first user and a GUI 1420 for sensing the ECG of a second user. The GUI 1410 for sensing the ECG of the first user may include a first part 1411 for a touch by the left hand of the first user and a second part 1412 for a touch by the right hand of the first user. The GUI 1420 for sensing the ECG of the second user may include a third part 1422 for a touch by the left hand of the second user and a fourth part 1421 for a touch by the right hand of the second user. The first part 1411 to the fourth part 1421 may correspond to a first area (not shown) to a fourth area (not shown) of the touch panel, respectively.

In operation 1330, the electronic device 101 may acquire electric signals from the plurality of areas of the touch panel corresponding to the displayed GUI. In operation 1340, the electronic device 101 may sense the ECG of each of the plurality of users by using the acquired electric signals. The electronic device 101 may sense the ECG of the first user based on a potential difference of the electric signals from the first area (not shown) and the second area (not shown) of the touch panel. The electronic device 101 may sense the ECG of the second user based on a potential difference of the electric signals from the third area (not shown) and the fourth area (not shown) of the touch panel.

According to the above description, the electronic device 101 may sense the ECGs of the plurality of users. The electronic device 101 according to an embodiment may sense ECGs of a plurality of users by using electric signals from a plurality of channels of one touch panel.

FIG. 14B is a diagram of an example of a GUI according to various embodiments. As illustrated in FIG. 14B, the electronic device 101 according to various embodiments may further display parts 1413 and 1423 for removing common mode noise on the GUIs 1410 and 1420. Although it is illustrated in FIG. 14B that the parts 1413 and 1423 for removing the common mode noise are to be touched by another finger of the right hand, the parts 1413 and 1423 may be touched by another finger of the left hand.

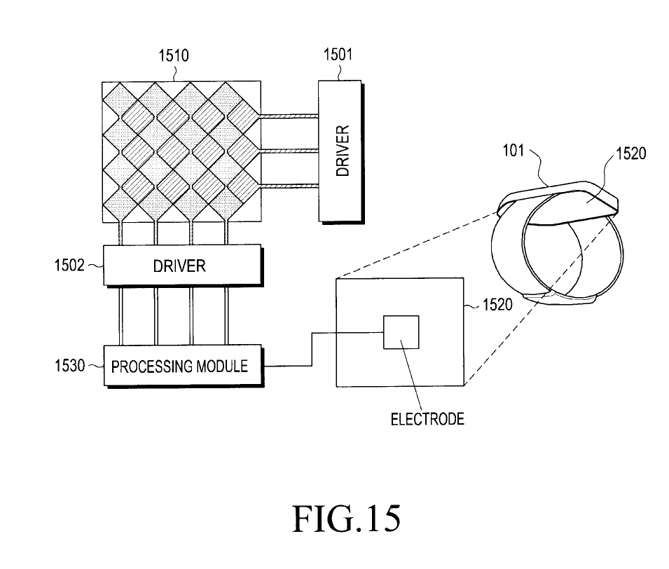

FIG. 15 is a diagram of an example of an electronic device, according to various embodiments.

The electronic device 101 according to the embodiment of FIG. 15 may include a touch panel 1510 and a metal electrode 1520. One or more drivers 1501 and 1502 for the scanning may be connected to the touch panel 1510. According to an embodiment, a processing module 1530 may sense an ECG by using an electric signal from the touch panel 1510 and an electric signal from the electrode 1520. The processing module 1530 may sense the ECG by correcting a level of the electric signal from the metal electrode 1520 to match a level of the electric signal from the touch panel 1510. Meanwhile, in the embodiment of FIG. 7, the electronic device 101 may include the touch panel 720 and, accordingly, the user may sense the ECG without direct contact with the touch panel 720. In FIG. 15, the ECG may be sensed as the user directly contacts the metal electrode 1520.

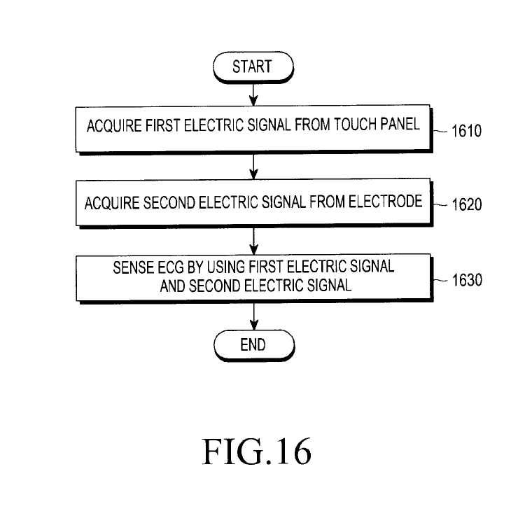

FIG. 16 is a flowchart of an example of a process, according to various embodiments.

In operation 1610, the electronic device 101 may acquire a first electric signal from the touch panel 1510. In operation 1620, the electronic device 101 may acquire a second electric signal from the metal electrode 1520. In operation 1630, the electronic device 101 may sense the ECG by using the first electric signal and the second electric signal. As described above, the method of controlling the electronic device may correct the second electric signal to match the first electric signal from the touch panel 1510 and sense the ECG by using the first electric signal and the corrected second electric signal. Alternatively, the method of controlling the electronic device may correct the first electric signal to match the second electric signal and sense the ECG by using the corrected first electric signal and the second electric signal.

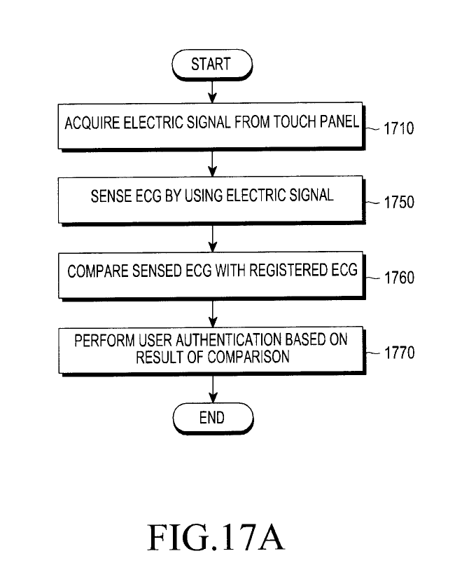

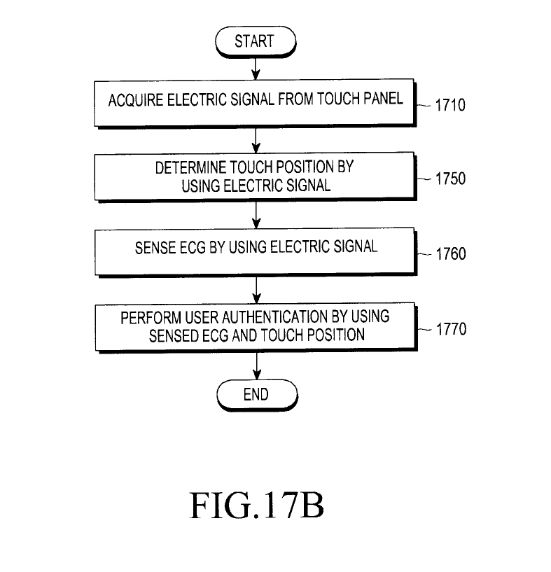

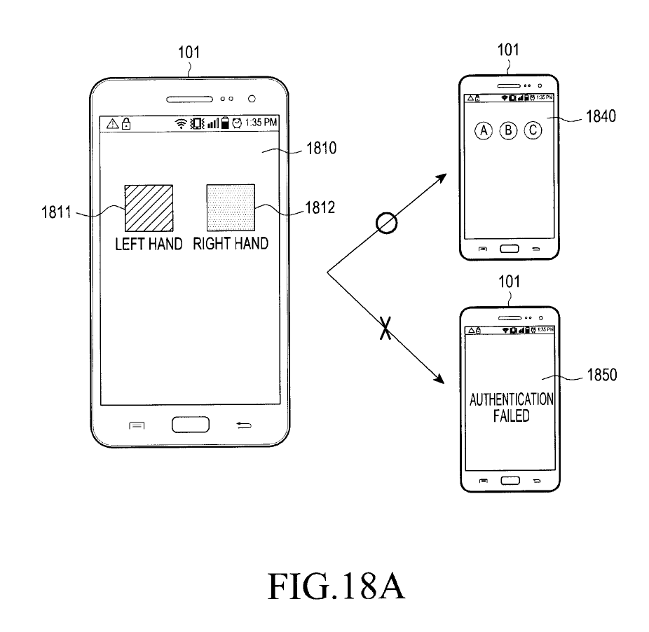

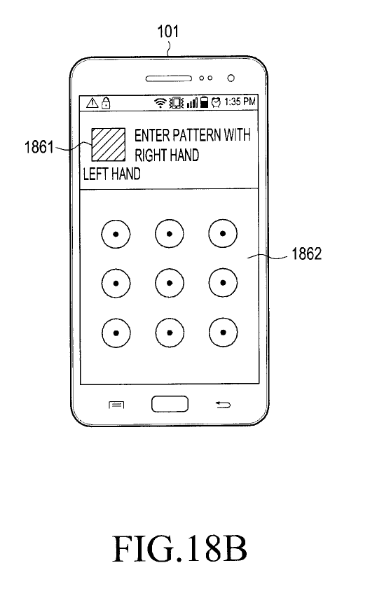

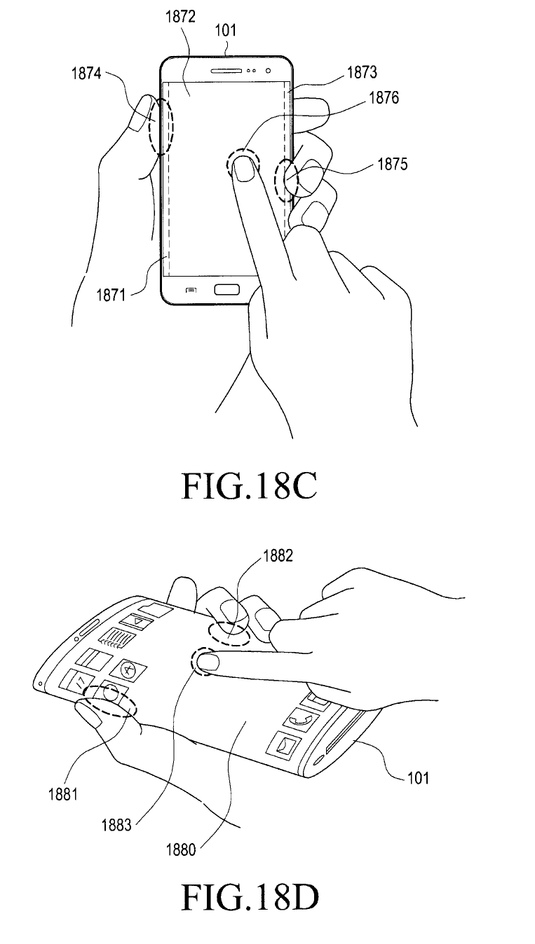

FIGS. 17A-B are flowcharts of examples of different processes, according to various embodiments. FIGS. 17A-B will be described with reference to FIGS. 18A-B. FIGS. 18A-B are diagrams of example(s) of an electronic device, according to various embodiments.

Referring to FIG. 17A, in operation 1710, the electronic device 101 may acquire electric signals from the touch panel. The electronic device 101 may acquire electric signals from at least two areas of the touch panel. For example, the electronic device 101 may display a GUI 1810 including parts 1811 and 1812 corresponding to two areas of the touch panel as illustrated in FIG. 18A. The user may touch the parts 1811 and 1812 corresponding to the two areas with both hands, and the touch panel may output electric signals from the user.

In operation 1720, the electronic device 101 may sense the ECG by using the electric signals.

In operation 1730, the electronic device 101 may compare the sensed ECG with the registered ECG. For example, the electronic device 101 may measure and register an ECG of a first user in advance. The electronic device 101 may perform a user authentication in operation 1740 according to whether the sensed ECG matches the registered ECG. When the authentication is successful, the electronic device 101 may display a menu screen 1840. When the authentication fails, the electronic device 101 may display an authentication failure message 1850.

Referring to FIG. 17B, the electronic device 101 may acquire an electric signal from the touch panel in operation 1710. In operation 1750, the electronic device 101 may determine a touch position by using the electric signal. In operation 1760, the electronic device 101 may sense the ECG by using the electric signal. As described above, the electronic device 101 according to various embodiments may simultaneously perform the ECG sensing and the touch position determination. In operation 1770, the electronic device 101 may perform the user authentication by using the sensed ECG and the touch position. This will be described with reference to FIG. 18B.

FIG. 18B is a diagram illustrating an example of an authentication screen of the electronic device, according to various embodiments. As illustrated in FIG. 18B, the electronic device 101 may display a GUI including a left hand touch part 1861 and a right hand touch part 1862. The electronic device 101 may display a pattern input window as the right hand touch part 1862. Accordingly, the user may touch the left touch part 1861 with the left hand and input a pattern into the right hand touch part 1862 with the right hand. The electronic device 101 may acquire a first electric signal from an area of the touch panel corresponding to the left hand part 1861. The electronic device 101 may acquire a second electric signal from an area of the touch panel corresponding to the right hand part 1862. The electronic device 101 may sense the ECG by using the first electric signal and the second electric signal. The electronic device 101 may perform a user authentication by comparing the sensed ECG with the registered ECG. The electronic device 101 may perform the user authentication by comparing the additionally input pattern with the registered pattern.

FIG. 18C is a diagram of an example of an electronic device, according to various embodiments of the present disclosure. The electronic device 101 according to the embodiment of FIG. 18C may include the touch panel in another part, which is not a front part 1876. The touch panel formed on the other part, which is not the front part, may be formed to be curved or linear. A first sub touch panel 1871 may be formed to be curved on a left side of a main touch panel 1872 and a second sub touch panel 1873 may be formed to be curved on a right side of the main touch panel 1872. The main touch panel 1872 may be integrally formed with the first sub touch panel 1871 and the second sub touch panel 1873. Accordingly, when the user grasps the side surface of the electronic device 101, the user may touch the first sub touch panel 1871 as indicated by reference numeral 1874 and touch the second sub touch panel 1873 as indicated by reference numeral 1875. Further, the electronic device 101 may measure an ECG and perform a user authentication whenever the user touches the main touch panel 1872 as indicated by reference numeral 1876.

FIG. 18D is a diagram of an example of an electronic device, according to various embodiments of the present disclosure. The electronic device 101 according to the embodiment of FIG. 18D may include a touch panel 1880 formed to be totally curved. Accordingly, even when the user grasps side surfaces of the electronic device 101, the user may touch left and right sides or a rear surface of the touch panel 1880 with the left hand as indicated by reference numerals 1881 and 1882. Further, the electronic device 101 may measure an ECG and perform a user authentication whenever the user touches the touch panel 1880 with the right hand as indicated by reference numeral 1883.

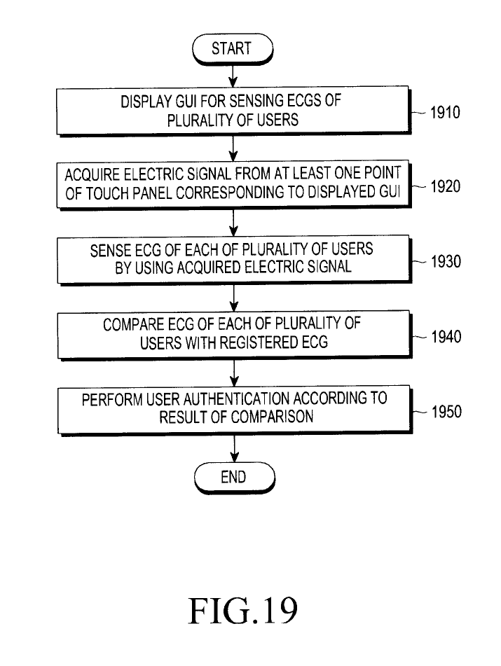

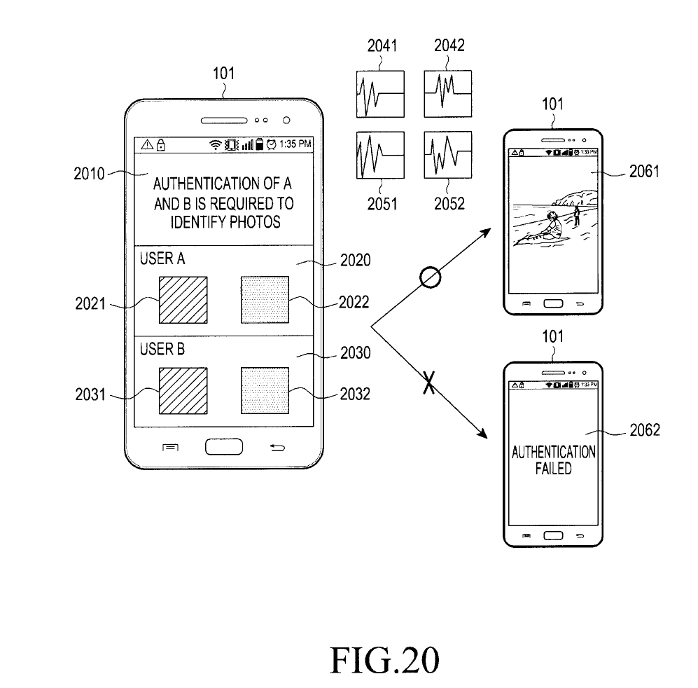

FIG. 19 is a flowchart of an example of a process, according to various embodiments. The embodiment of FIG. 19 will be described with reference to FIG. 20. FIG. 20 is a diagram of an example of an electronic device, according to various embodiments.

In operation 1910, the electronic device 101 may display a GUI 2010 for sensing ECGs of a plurality of users as illustrated in FIG. 20. The GUI 2010 for sensing the ECGs of the plurality of users according to various embodiments may include a GUI 2020 for sensing an ECG of a first user and a GUI 2030 for sensing an ECG of a second user. The GUI 2020 for sensing the ECG of the first user may include a part 2021 for a touch by the left hand of the first user and a part 2022 for a touch by the right hand of the first user, and the GUI 2030 for sensing the ECG of the second user may include a part 2031 for a touch by the left hand of the second user and a part 2032 for a touch by the right hand of the second user.

In operation 1920, the electronic device 101 may acquire an electric signal from at least one point of the touch panel corresponding to the displayed GUI. For example, the first user may touch the part 2021 for the touch by the left hand and the part 2022 for the touch by the right hand with the left hand and the right hand, respectively, and the second user may touch the part 2031 for the touch by the left hand and the part 2032 for the touch by the right hand with the left hand and the right hand, respectively. The electronic device 101 may acquire electric signals 2041 and 2042 from areas of the touch panel corresponding to the part 2021 for the touch by the left hand of the first user and the part 2022 for the touch by the right hand of the first user. The electronic device 101 may acquire electric signals 2051 and 2052 from areas of the touch panel corresponding to the part 2031 for the touch by the left hand of the second user and the part 2032 for the touch by the right hand of the second user.

In operation 1930, the electronic device 101 may sense the ECG of each of the plurality of users by using the acquired electric signals. The electronic device 101 sense the ECG of the first user by using the electric signals 2041 and 2042 received from the areas of the touch panel corresponding to the part 2021 for the touch by the left hand of the first user and the part 2022 for the touch by the right hand of the first user. The electronic device 101 may sense the ECG of the second user by using the electric signals 2051 and 2052 received from the areas of the touch panel corresponding to the part 2031 for the touch by the left hand of the second user and the part 2032 for the touch by the right hand of the second user.

In operation 1940, the electronic device 101 may compare the ECG of each of the plurality of users with the registered ECG. In operation 1950, the electronic device 101 may perform the user operation according to a result of the comparison. For example, when the authentication is successful, the electronic device 101 may display a security-processed photo 2061, which requires authentications of both the first user and the second user. When the authentication fails, the electronic device 101 may display an authentication failure message 2062.

Meanwhile, the electronic device 101 may perform the authentication of the first user for a first period and, when the authentication of the first user is completed, perform the authentication of the second user for a second period. In this case, the electronic device 101 may display a GUI for a single person authentication for the authentication of the first user and a GUI for a single person authentication for the authentication of the second user.

According to the above description, the electronic device 101 according to various embodiments may provide a method of performing authentications of a plurality of users.

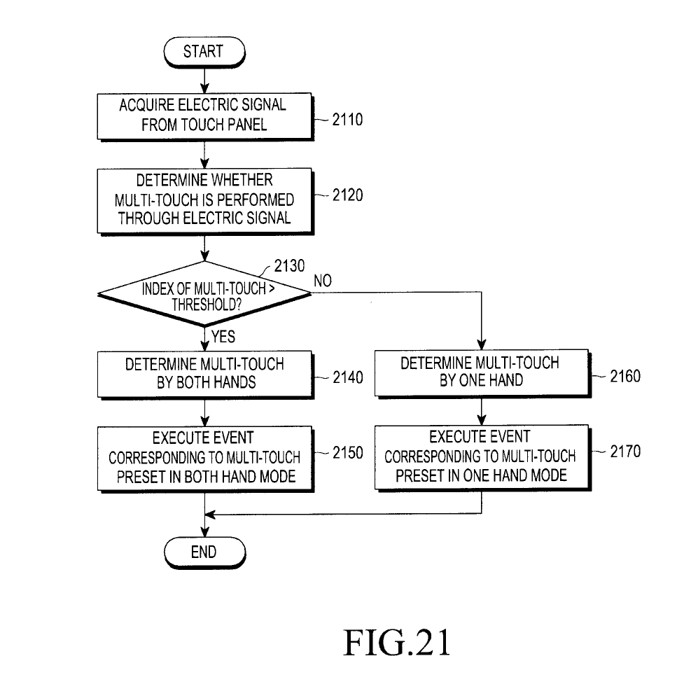

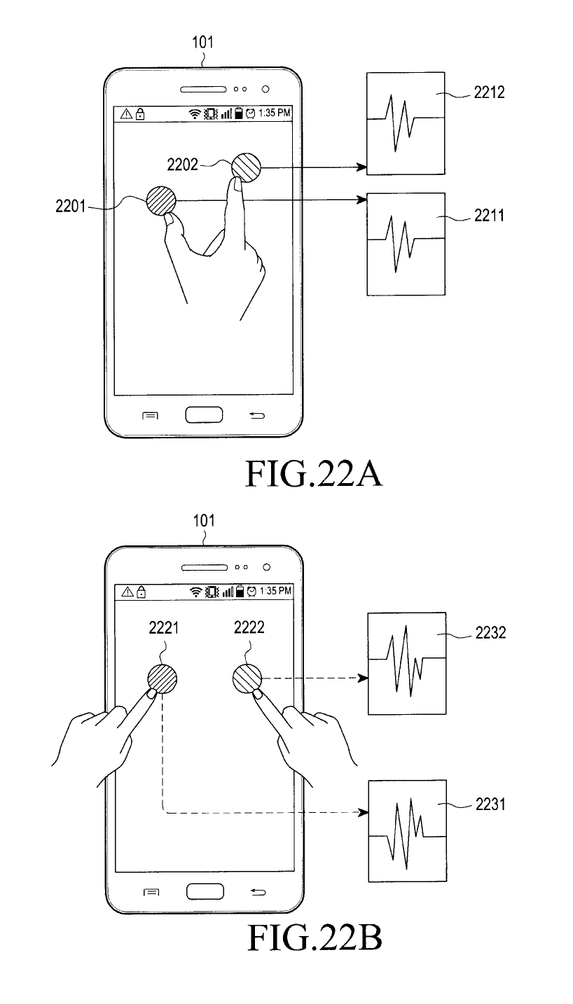

FIG. 21 is a flowchart of an example of a process, according to various embodiments. The embodiment of FIG. 21 will be described with reference to FIGS. 22A and 22B. FIGS. 22A and 22B are diagrams illustrating example(s) of an electronic device, according to various embodiments.

In operation 2110, the electronic device 101 may acquire electric signals from the touch panel. In operation 2120, the electronic device 101 may determine, through the electric signals, whether a multi-touch is made. For example, as illustrated in FIG. 22A, the electronic device 101 may determine whether a plurality of areas are touched by acquiring electric signals from a first area 2201 of the touch panel and a second area 2202 of the touch panel. The touch in the first area 2201 is referred to as a first touch and the touch in the second area 2202 is referred to as a second touch.

In operation 2130, the electronic device 101 may determine whether at least one of the indicators of a potential difference of the electric signals corresponding to the multi-touch, that is, the first touch and the second touch is larger than a threshold. When at least one of the indicators of the potential difference of the electric signals corresponding to the first touch and the second touch is larger than the threshold, the electronic device 101 may determine that the first touch and the second touch correspond to the multi-touch made by both hands, respectively. In operation 2150, the electronic device 101 may perform a preset event corresponding to the multi-touch in a multiple hand mode. Meanwhile, when at least one of the indicators of the potential difference of the electric signals corresponding to the first touch and the second touch is equal to or smaller than the threshold, the electronic device 101 may determine that the first touch and the second touch correspond to the multi-touch made by one hand. In operation 2170, the electronic device 101 may perform a preset event corresponding to the multi-touch in a one hand mode.

For example, referring to FIG. 22A, the user may touch the first area 2201 and the second area 2202 with one hand. As described above, one hand is included in one side of the zero potential line and, accordingly, the difference between the electric signals 2211 and 2212 from the first area 2201 and the second area 2202 may be relatively small. Accordingly, the electronic device 101 may determine whether a multi-touch is made by one hand based on the difference between electric signals.

Meanwhile, referring to FIG. 22B, the user may touch the first area 2221 and the second area 2222 with both hands. In this case, since one hand is included in one side of the zero potential line and the other hand is included in the other side of the zero potential line, the difference between electric signals 2231 and 2232 from the first area 2221 and the second area 2222 may be relatively large. Accordingly, the electronic device 101 may determine whether a multi-touch is made by both hands based on the difference between electric signals.

That is, according to an embodiment, when the indicator of the potential difference is the potential difference of the multi-touch, the electronic device 101 may determine whether the multi-touch is made by one hand or both hands according to whether the potential difference of the multi-touch is larger than the threshold. When it is determined that the potential difference of the multi-touch is larger than a threshold, the electronic device 101 may determine that the multi-touch is made by both hands. When it is determined that the potential difference of the multi-touch is equal to or smaller than the threshold, the electronic device 101 may determine that the multi-touch is made by one hand.

According to another embodiment, the indicator of the potential difference may be a strength of the potential difference of the multi-touch in a first frequency band. In this case, when the strength of the potential difference of the multi-touch in the first frequency band is larger than a threshold, the electronic device 101 may determine that the multi-touch is made by both hands. When the strength of the potential difference of the multi-touch in the first frequency band is equal to or smaller than the threshold, the electronic device 101 may determine that the multi-touch is made by one hand. As described above, the ECG signal may be formed in the first frequency band and, accordingly, when the strength of the signal in the first frequency corresponding to the ECG signal is larger than a threshold, the electronic device 101 may determine that the multi-touch is made by both hands.

According to another embodiment, the indicator of the potential difference may be a similarity between the potential difference of the multi-touch and a pre-stored ECG template. In this case, when the similarity between the potential difference of the multi-touch and the pre-stored ECG template is larger than a threshold, the electronic device 101 may determine that the multi-touch is made by both hands. When the similarity between the potential difference of the multi-touch and the pre-stored ECG template is equal to or smaller than the threshold, the electronic device 101 may determine that the multi-touch is made by one hand.

According to various embodiments, the electronic device 101 may perform different operations according to whether the multi-touch is made by one hand or both hands in spite of being the same multi-touch. Table 1 shows examples of multi-touch processing operations according to various embodiments.

TABLE 1

| Multi- | Multi-touch by | |
|---|---|---|
| touch type | one hand | Multi-touch by both hands |
| press/hold | Capture screen | Sense heart rate and perform |
| | | authentication |
| double | Enter | Sense heart rate and perform |
| tap | | short-cut operation (for example, |
| | | camera operation) |
| slide | Display previous or | Sense heart rate and lock or |
| | next item | unlock |
| swipe | Shift page | Sense heart rate and control |
| | | volume |
| pinch/stretch | Zoom in/out | Sense heart rate and activate |
| | | multi-window |
| turn | Rotate | Sense heart rate and change |
| | | mode (for example, personal mode) |

As described above, the electronic device 101 according to various embodiments may differently process the same multi-touch according to whether the multi-touch is an input by one hand or an input by both hands. Table 1 is only an example, and there is no limitation on the operation corresponding to the multi-touch.

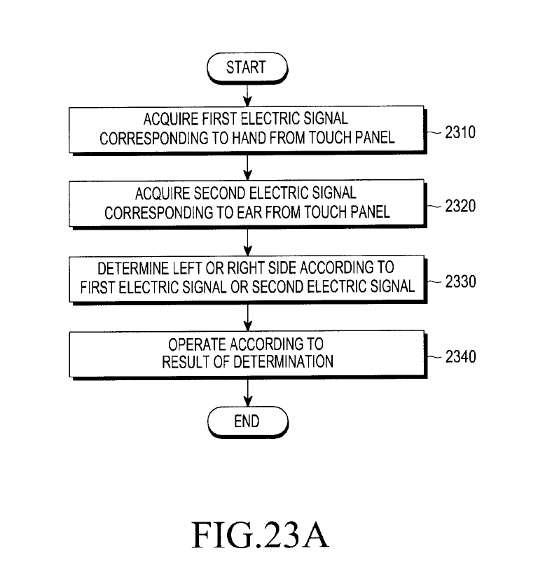

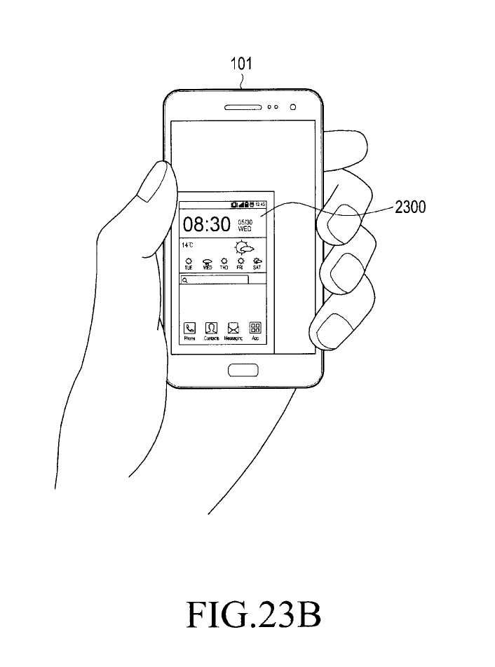

The electronic device 101 may measure the potential difference of electric signals acquired from the touch panel through a processing module for the ECG sensing. FIG. 23A is a flowchart of a method of controlling the electronic device according to various embodiments. The embodiment of FIG. 23A will be described with reference to FIG. 23B. FIG. 23B illustrates an example of a screen control method, according to various embodiments.

In operation 2310, the electronic device 101 may acquire a first electric signal corresponding to the hand from the touch panel. In operation 2320, the electronic device 101 may acquire a second electric signal corresponding to an ear from the touch panel. For example, the electronic device 101 may acquire the first electric signal from the touch panel disposed on the side surface or rear surface and acquire the second electric signal from the touch panel disposed on the front surface.

In operation 2330, the electronic device 101 may determine left and right information according to the first electric signal or the second electric signal. In operation 2340, the electronic device 101 may operate according to the determined left and right information. For example, the electronic device 101 may pre-store a signal waveform generated in one side and the other side of the zero potential line. The electronic device 101 may determine whether a touched hand is a left hand or a right hand by comparing the first electric signal with the pre-stored signal waveform. Alternatively, the electronic device 101 may determine whether a touched ear is a left ear or a right ear by comparing the second electric signal with the pre-stored signal waveform. The electronic device 101 may operate according to whether the hand is the left hand or the right hand. For example, when it is determined that the user grasps the electronic device 101 with the left hand as illustrated in FIG. 23B, the electronic device 101 may provide a screen 2300 which can be easily used by the left hand. Alternatively, the electronic device 101 may control a volume corresponding to the determined ear by using pre-stored information on hearing of both ears of the user. Alternatively, the electronic device 101 may determine a call position based on the left and right information on the touched ear and hand and perform a matching change of an antenna corresponding to the determined call position. Alternatively, the electronic device 101 may determine the touched ear and change a left and right stereo setting or guide a correct wearing method for left and right ears.

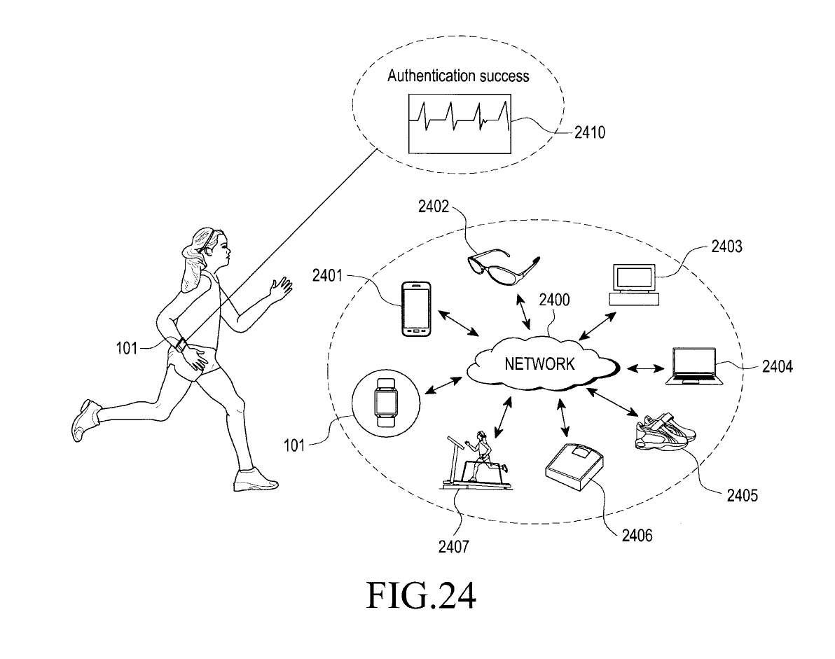

FIG. 24 is a diagram of an example of a system, according to various embodiments.

As illustrated in FIG. 24, the user may wear the electronic device 101, and the electronic device 101 may sense an ECG based on an electric signal from the touch panel. The electronic device 101 may perform an authentication by using the ECG and share authentication information 2410 with other electronic devices 2401 to 2407 through a network 2400. The electronic device 101 may transmit the ECG to the other electronic devices 2401 to 2407. Meanwhile, one of the other electronic devices 2401 to 2407 may generate user notification information. Meanwhile, the other electronic devices 2401 to 2407 may determine the electronic device 101 having transmitted the authentication information 2410 as an electronic device, which the user is wearing or using. Accordingly, the electronic device having generated the user notification information may transmit the notification information to the electronic device, which the user wears, that is, the electronic device 101. The electronic device 101 may output the received notification information and the user may identify the output notification information.

As described above, according to various embodiments, the electronic device having sensed the ECG may be determined as the electronic device, which the user is wearing or using.

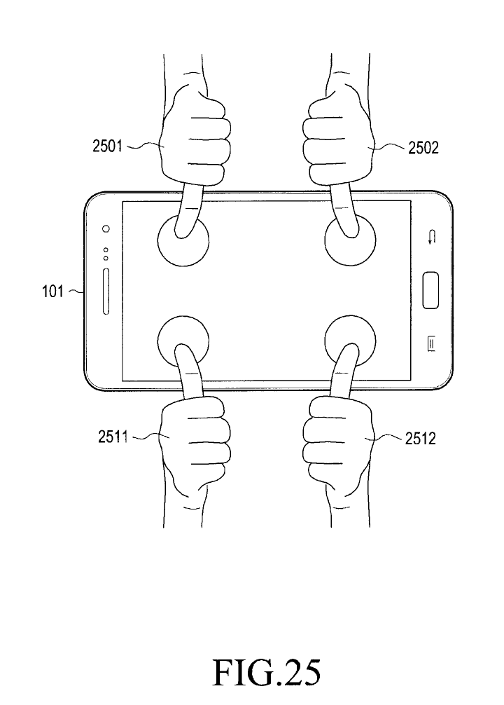

FIG. 25 is a diagram of an example of an electronic device, according to various embodiments.

As illustrated in FIG. 25, the electronic device 101 may acquire electric signals from both hands 2501 and 2502 of a first user and electric signals from both hands 2511 and 2512 of a second user. The electronic device 101 may sense an ECG of the first user based on the electric signals from both hands 2501 and 2502 of the first user and an ECG of the second user based on the electric signals from both hands 2511 and 2512 of the second user. The electronic device 101 may operate by using the ECGs of the two users. For example, the electronic device 101 may determine likability of the two users by using the ECGs of the two users and display the likability.

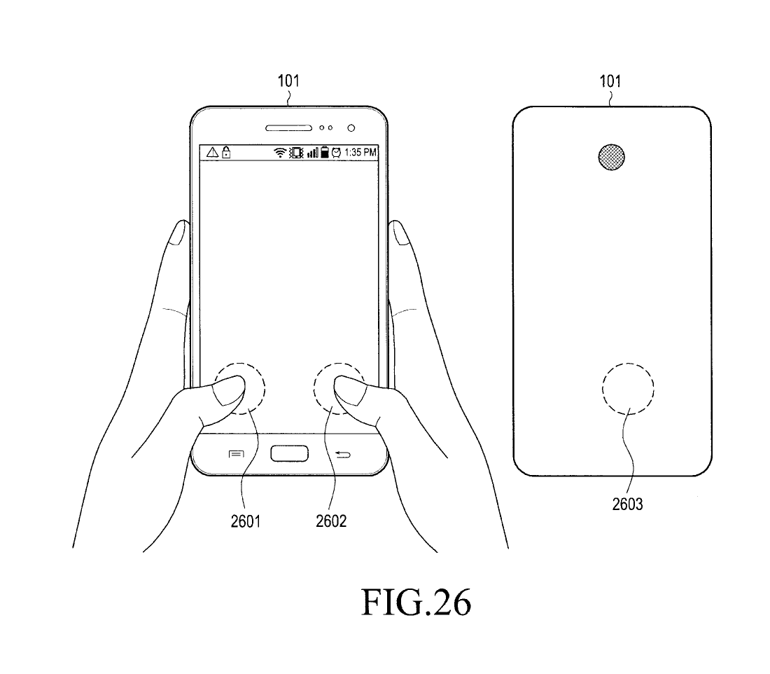

FIG. 26 is a diagram of an example of an electronic device, according to various embodiments.

As illustrated in FIG. 26, the electronic device 101 may display a first part 2601 and a second part 2602 corresponding to a first area and a second area of the touch panel for the ECG sensing. Although it is illustrated that y axis locations of the first part 2601 and the second part 2602 are the same in the embodiment of FIG. 26, there is no limitation on locations of the first part 2601 and the second part 2602 and the locations may be variable.

Meanwhile, a third area 2603 for removing common mode noise may be located on the rear surface of the electronic device 101. The electronic device 101 may include a touch panel or a metal electrode including the third area 2603 on the rear surface. The user may touch the third area 2603 with one hand while contacting the first part 2601 and the second part 2602 with both hands, and the electronic device 101 may sense the ECG based on electric signals from the first area 2601 and the second area 2602 and apply an inverse phase signal of the common mode noise to the third area 2603.

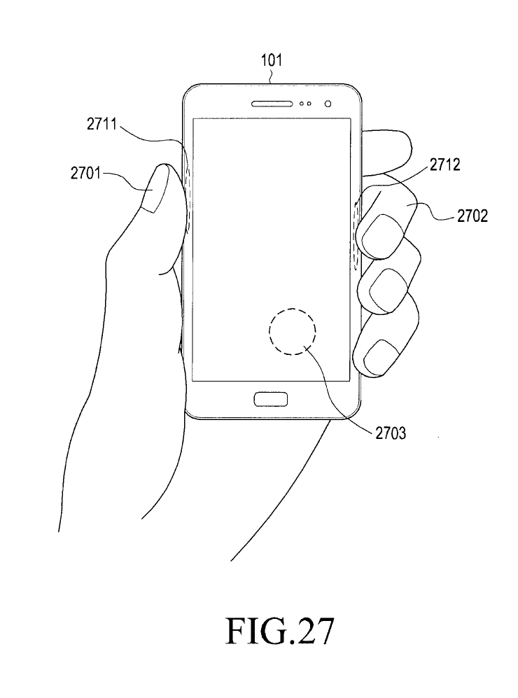

FIG. 27 is a diagram of an example of an electronic device, according to various embodiments.

As illustrated in FIG. 27, the electronic device 101 may include touch panels 2711 and 2712 disposed on side surfaces and a touch panel 2703 disposed on the front surface. Although it is illustrated that the touch panel 2703 disposed on the front surface and the touch panels 2711 and 2712 disposed on the side surfaces are physically separated from each other, it is only an example and the electronic device 101 may include an integral touch panel disposed on the side surface and the front surface. In the embodiment of FIG. 27, the user may grasp the electronic device 101 with the left hand. In this case, a thumb 2701 of the user may touch the touch panel 2711 and a middle finger 2702 of the user may touch the touch panel 2712. Meanwhile, the user may touch the touch panel 2703 on the front surface with the right hand. The electronic device 101 may sense the ECG based on a first electric signal from one of the touch panels 2711 and 2712 disposed on the side surfaces and a second electric signal from the touch panel 2703 disposed on the front surface. Further, the electronic device 101 may apply an inverse phase signal of common mode noise of the first electric signal and the second electric signal to the other one of the touch panels 2711 and 2712 disposed on the side surfaces. For example, when the user touches the front touch panel 2703 with the right hand while grasping the electronic device 101 with the left hand as illustrated in FIG. 27, the electronic device 101 may sense the ECG. Accordingly, the electronic device 101 may sense the ECG whenever the user grasps the electronic device 101 with the left hand and inputs a touch with the right hand. Meanwhile, the electronic device 101 may provide different functions corresponding to touch positions on the touch panels 2711 and 2712 disposed on the side surfaces. For example, the electronic device 101 may operate according to a touch of another finger which is not required for the ECG sensing.

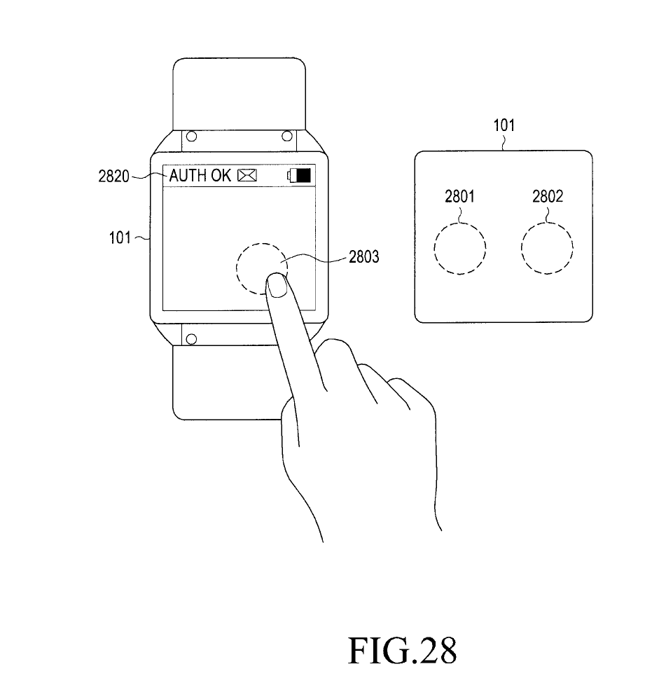

FIG. 28 is diagram of an example of an electronic device, according to various embodiments.

As illustrated in FIG. 28, the electronic device 101 may be implemented as, for example, a wrist watch type wearable electronic device. The electronic device 101 may include a first area 2801 and a second area 2802 on the rear surface. The first area 2801 and the second area 2802 may be used for acquiring a first electric signal for the ECG sensing or removing common mode noise. For example, when the user wears the electronic device 101 on a left wrist, the first area 2801 and the second area 2802 may contact the left wrist. The user may touch a third area 2803 disposed on the front surface of the electronic device 101 with a right finger. The electronic device 101 may acquire a second electric signal for the ECG sensing from the third area 2803. The electronic device 101 may sense the ECG by using the first electric signal and the second electric signal. The electronic device 101 may perform a user authentication by using the ECG and display a result 2820 of the authentication.

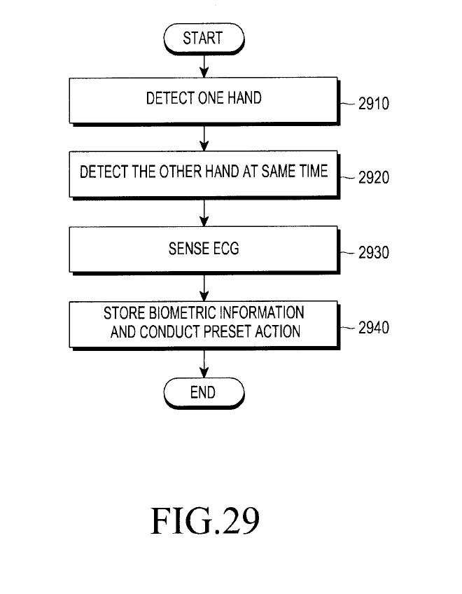

FIG. 29 is a flowchart of an example of a process, according to various embodiments.

In operation 2910, the electronic device 101 may detect a touch by one hand. In operation 2920, the electronic device 101 may detect a touch by the other hand simultaneously with the touch by the one hand. In operation 2930, the electronic device 101 may sense the ECG by using a first electric signal corresponding to the touch by the one hand and a second electric signal corresponding to the touch by the other hand. In operation 2940, the electronic device 101 may store biometric information and perform a preset action. The electronic device 101 may store the biometric information as accumulated information and display the biometric information on an indication bar. Further, the electronic device 101 may perform an operation of executing an application, executing a short-cut, and controlling a volume in accordance with the biometric information.

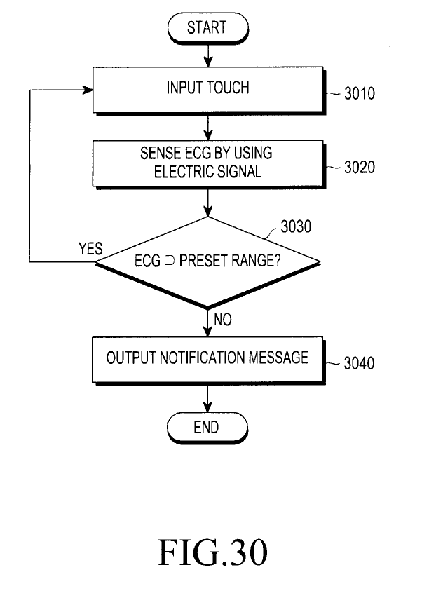

FIG. 30 is a flowchart of an example of a process, according to various embodiments.

In operation 3010, the electronic device 101 may receive a plurality of touch inputs from the user. In operation 3020, the electronic device 101 may sense the ECG by using electric signals by the touches. In operation 3030, the electronic device 101 may determine whether the ECG is included within a preset range. The preset range may correspond to a normal range of the ECG. When it is determined that the ECG is not included in the preset range, the electronic device 101 may output a notification message in operation 3040. The electronic device 101 may display the notification message or transmit the notification message to another electronic device through communication.

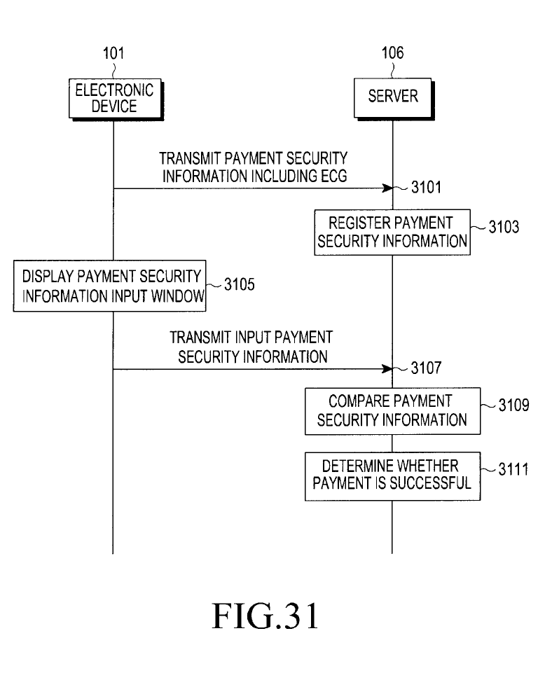

FIG. 31 is a flowchart of an example of a process, according to various embodiments.

In operation 3101, the electronic device 101 may transmit payment security information including the ECG to the server 106. In operation 3103, the server 106 may register the payment security information. Accordingly, the server 106 may store the payment security information according to each user.

In operation 3105, the electronic device 101 may display a payment security information input window. The electronic device 101 may receive the payment security information through the payment security information input window, and transmit the payment security information to the server 106 in operation 3107. The payment security information may include the ECG. In operation 3109, the server 106 may compare the received payment security information with registered payment security information. In operation 3111, the server 106 may determine whether the payment is successful according to a result of the comparison.

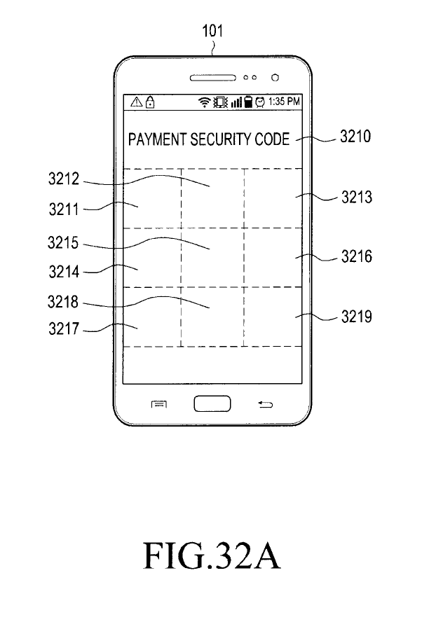

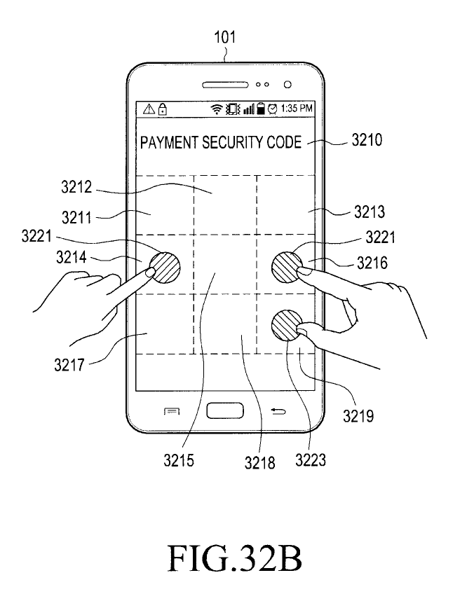

FIGS. 32A and 32B are diagrams illustrating example(s) of payment security information, according to various embodiments.

As illustrated in FIG. 32A, the electronic device 101 may display a payment security information input window 3210 including a plurality of input areas 3211 to 3219. The user may touch a fourth area 3214 with one finger of the left hand, touch a sixth area 3216 with one finger of the right hand, and touch a ninth area 3219 with another finger of the right hand as illustrated in FIG. 32B. The electronic device 101 may determine the touched areas 3214, 3216, and 3219 and sense the ECG by using electric signals from some of the touched areas, for example, the fourth area 3214 and the sixth area 3216. The electronic device 101 may manage the touched areas and the sensed ECG as the payment security information. That is, when registering the payment security information, the electronic device 101 may register the acquired payment security information in the server 106. Further, when performing payment, the electronic device 101 may transmit the acquired payment security information to the server 106 to authenticate the payment.

According to various embodiments, a method of controlling an electronic device including a touch panel may include: an operation of acquiring a first electric signal from a first area of the touch panel and acquiring a second electric signal from a second area of the touch panel; an operation of determining whether one or more of indicators of a potential difference of the first electric signal and the second electric signal is larger than a preset threshold; and an operation of determining whether a first touch corresponding to the first area and a second touch corresponding to the second area are made by one hand or both hands according to whether the one or more of the indicators of the potential difference of the first electric signal and the second electric signal is larger than the preset threshold.

According to various embodiments, the operation of determining whether the first touch corresponding to the first area and the second touch corresponding to the second area are made by one hand or both hands may include: an operation of, when the one or more of the indicators of the potential difference of the first electric signal and the second electric signal is larger than the preset threshold, determining that the first touch and the second touch are made by both hands; or an operation of, when the one or more of the indicators of the potential difference of the first electric signal and the second electric signal is equal to or smaller than the preset threshold, determining that the first touch and the second touch are made by one hand.

According to various embodiments, the method may further include, an operation of, when it is determined that the first touch and the second touch are made by both hands, performing a preset event corresponding to the first touch and the second touch by both hands; or an operation of, when it is determined that the first touch and the second touch are made by one hand, performing a preset event corresponding to the first touch and the second touch by one hand.

According to various embodiments, the operation of determining whether the first touch corresponding to the first area and the second touch corresponding to the second area are made by one hand or both hands may include an operation of, when the indicator of the potential difference is the potential difference of the first electric signal and the second electric signal, determining that the first touch and the second touch are made by both hands if it is determined that the potential difference is larger than a first threshold and determining that the first touch and the second touch are made by one hand if it is determined that the potential difference is equal to or smaller than the first threshold; an operation of, when the indicator of the potential difference is a strength of the potential difference of the first electric signal and the second electric signal in a first frequency band, determining that the first touch and the second touch are made by both hands if it is determined that the strength in the first frequency band is larger than a second threshold and determining that the first touch and the second touch are made by one hand if it is determined that the strength in the first frequency band is equal to or smaller than the second threshold; or and an operation of, when the indicator of the potential difference is a similarity between the potential difference of the first electric signal and the second electric signal and a pre-stored ECG template, determining that the first touch and the second touch are made by both hands if it is determined that the similarity is larger than a third threshold and determining that the first touch and the second touch are made by one hand if it is determined that the similarity is equal to or smaller than the third threshold.

According to various embodiments, the indicators of the potential difference of the first electric signal and the second electric signal, acquired through the touch panel may be measured by a processing module for ECG sensing.

FIGS. 1-32B are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the FIGS. may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

What is claimed is:

1. A method for controlling an electronic device including a touch panel, the method comprising:
acquiring a first signal from a first area of the touch panel and acquiring a second signal from a second area of the touch panel;
detecting whether a potential difference of the first signal and the second signal is larger than a preset threshold; and
detecting whether a first touch corresponding to the first area and a second touch corresponding to the second area are performed by using one hand based on whether the potential difference of the first signal and the second signal is larger than the preset threshold.

2. The method of claim 1, wherein detecting whether the first touch and the second touch are performed by using one hand comprises:
when the potential difference of the first signal and the second signal is larger than the preset threshold, detecting that the first touch and the second touch are performed by using two hands; or
when the potential difference of the first signal and the second signal is equal to or smaller than the preset threshold, detecting that the first touch and the second touch are performed by using one hand.

3. The method of claim 2, further comprising:
when it is detected that the first touch and the second touch are performed by using two hands, generating a first event; or
when it is detected that the first touch and the second touch are performed by using one hand, generating a second event.

4. The method of claim 1, wherein detecting whether the potential difference of the first signal and the second signal is larger than the preset threshold is performed based on at least one of an electrocardiogram (ECG) template, and a predetermined frequency band.

5. The method of claim 1, wherein the potential difference of the first signal and the second signal is measured by using an ECG sensing module.

6. An electronic device comprising:
a touch panel;
a memory; and
at least one processor operatively coupled to the memory, configured to:
acquire a first signal from a first area of the touch panel and acquiring a second signal from a second area of the touch panel;
detect whether a potential difference of the first signal and the second signal is larger than a preset threshold; and
detect whether a first touch corresponding to the first area and a second touch corresponding to the second area are performed by using one hand based on whether the potential difference of the first signal and the second signal is larger than the preset threshold.

7. The electronic device of claim 6, wherein detecting whether the first touch and the second touch are performed by using one hand comprises:
when the potential difference of the first signal and the second signal is larger than the preset threshold, detecting that the first touch and the second touch are performed by using two hands; or
when the potential difference of the first signal and the second signal is equal to or smaller than the preset threshold, detecting that the first touch and the second touch are performed by using one hand.

8. The electronic device of claim 7, wherein the at least one processor is further configured to:
generate a first event when it is detected that the first touch and the second touch are performed by using two hands; or
generate a second event when it is detected that the first touch and the second touch are performed by using one hand.

9. The electronic device of claim 6, wherein detecting whether the potential difference of the first signal and the second signal is larger than the preset threshold is performed based on at least one of an electrocardiogram (ECG) template, and a predetermined frequency band.

10. The electronic device of claim 6, further comprising a processing module for measuring the potential difference of the first signal and the second signal.

11. An electronic device comprising:
a touch panel arranged to acquire a plurality of electric signals;
a filter arranged to pass a first frequency band, the filter being operatively coupled to the touch panel;
a memory, and
at least one processor operatively coupled to the memory, configured to:
sense an electrocardiogram (ECG) by using a first signal from the plurality of electric signals being in the first frequency band;
identify a touch position on the touch panel by using a second signal from the plurality of electric signals being in a second frequency band.

12. The electronic device of claim 11, wherein the at least one processor is further configured to perform an operation by using at least one of the ECG and the touch position.

13. The electronic device of claim 11, wherein the first signal is output from a first area of the touch panel and the second signal is output from a second area of the touch panel.

14. The electronic device of claim 13, wherein the ECG is sensed based on a potential difference of the first signal and the second signal.

15. The electronic device of claim 13, wherein the at least one processor is further configured to detect whether a first touch corresponding to the first area and a second touch corresponding to the second area are performed by using one hand according to whether a potential difference of the first signal and the second signal is larger than a preset threshold.

16. The electronic device of claim 15, wherein the at least one processor is further configured to:
generate a first event when it is detected that the first touch and the second touch are performed by using two hands; or
generate a second event when it is detected that the first touch and the second touch are performed by using one hand.

17. The electronic device of claim 13, further comprising a feedback circuit arranged to extract common mode noise of the first signal and the second signal and output to a third area of the touch panel an inverse phase signal of the common mode noise.

18. The electronic device of claim 13, wherein the first area and the second area correspond to one or more channels of the touch panel.

19. The electronic device of claim 15, wherein detecting whether the potential difference of the first signal and the second signal is larger than the preset threshold is performed based on at least one of an ECG template, and a predetermined frequency band.

20. An electronic device comprising:
a touch panel in which electrode cells are connected or separated through Thin Film Transistors (TFTs);
a memory;
at least one processor operatively coupled to the memory, configured to:
select whether to identify a touch position on the touch panel or sense an ECG of a user, and
cause the electrode cells to be connected or separated from each other through the TFTs according to an outcome of the selection.
